(19) United States
(12) Patent Application Publication
(10) Pub. No.: US 2007/0156544 A1
(43) Pub. Date: Jul. 5, 2007

(54) Identity preservation and tracing system

(75) Inventors: Daron Duane Meyer, Orono, MN (US); David Gene Dayhoff, Minneapolis, MN (US); Ruth Shyrl Kimmelshue, Minnetonka, MN (US)

Correspondence Address: SHUMAKER & SIEFFERT, P. A., 1625 RADIO DRIVE, SUITE 300, WOODBURY, MN, 55125, US

(73) Assignee: Cargill, Inc., Wayzata, MN (US)

(21) Appl. No.: 11/492,303

(22) Filed: Jul. 25, 2006

Related U.S. Application Data
(60) Provisional application No. 60/702,739, filed on Jul. 27, 2005.

(51) Int. Cl. A23K 1/22; G06Q 10/00

(52) U.S. Cl. 705/28; 426/69

(57) ABSTRACT

Producers and handlers of various grown commodities commingle products together during storage and transportation. The commingling of similar varieties of products with different attributes or characteristics makes it difficult to distinguish between like products. A system is described that tracks lots of these products from their creation through the entire storage and transportation process, which can be very complex. Furthermore, the system integrates tracking data from one or more enterprise software systems. Specifically, the enterprise software systems collect tracking data along with data normally collected by the enterprise software systems. The enterprise software systems submit the tracking data to an integration module of the identity preservation and tracing system in formats that comply with one or more business activity definitions installed with the integration module. The integration module verifies the tracking data and records the tracking data into the product identity preservation and tracing system.

This application claims the benefit of U.S. Provisional Application Ser. No. 60/702,739, filed Jul. 27, 2005, the entire content of which is incorporated herein by reference.

### TECHNICAL FIELD

The invention generally relates to product handling and, more specifically, to the movement, tracking and storage of products.

### BACKGROUND

In general, producers typically create products, store them in a local storage facility, and deliver the products to a customer that makes use of the product in some fashion. A supply chain provides a link between producers and customers, and typically includes any number of intermediaries that handle, transport, and store the product. For many items, the products are unaffected by the storage and handling process. A car manufacturer, for example, builds an automobile, places it on a truck or ship, and sends it to a dealer. The dealer holds or “stores” the automobile for some time until a customer purchases that automobile and takes delivery. If the automobile were damaged during this time period, the damage would be readily apparent and readily traceable to the intermediary.

However, there are many products that are not readily individually identifiable, and that storage, transportation, handling and/or processing potentially alters. For example, farmers produce and harvest many commodities in bulk, such as grain, seeds, corn, soybeans, or any number of other crops, then store and transport these commodities together in large quantities. As the commodity is harvested, the farmer stores the commodity in a bulk storage facility, such as a bin having many thousands of bushels of grain or seeds. The farmer delivers the commodities to an elevator that stores and distributes commodities received from a number of different farmers. The elevator transfers the commodities to an appropriate transportation device, such as a barge, truck or rail car and the commodity is delivered to either a customer or another intermediate storage facility.

Participants in a commodity supply chain have generally considered different varieties of a commodity to be uniform and indistinguishable. For example, all number 2 yellow corn was considered the same, whether farmer A or farmer B produced it. Thus, participants could mix these products together for storage and transport, and the customer that purchased the commodities was generally indifferent.

Technological advances in seed development, crop production, and grain/oilseed handling and processing have altered the previous commodity paradigm and have made product differentiation between the same product with different attributes an increasingly important factor for many customers and consumers to consider. These attributes indicating the character of the product can vary widely, such as the hardness of the kernels, the seed's oil content or protein content, the seed variety, whether the seeds were bio-engineered, etc. Much attention has recently been focused on bio-engineered products, with some customers and consumers seeking products with certain bio-engineered attributes and others seeking products without such attributes that have been produced by conventional development methods. Still other customers and consumers may seek assurances that they are receiving “organically produced” agricultural products (See the Federal Organic Foods Production Act of 1990, U.S.C. Title 7, Ch.9, § 6501 et seq. and the U.S.D.A. National Organic Program, effective Dec. 21, 2000, 7 C.F.R. Part 205 et seq.).

As attributes in the grain or seed become more and more specialized (either through bio-engineering or conventional development methods), there is an increased need to be able to prove that the raw materials delivered to the customer are, in fact, what were promised. That is, customers often want to know more than just the type of commodity they are receiving, such as number 2 yellow corn. Instead the customers are looking for some sort of documentation that the product delivered to them contains the higher value attribute they have purchased. Unfortunately, there is often no easy way to tell by analyzing the resultant product. Soybeans with elevated levels of protein look the same as soybeans with standard protein content. Bio-engineered products are visually indistinguishable from their conventional cousins. Unfortunately, tests to identify grains with unique attributes have generally been inaccurate, unreliable, expensive, time consuming, and sometimes not available.

In an attempt to provide appropriate assurances to receivers of differentiated products, various processes have been developed to establish the history of a given shipment, or lot, of a commodity. For example, the farmer may initially document the variety of seed being utilized, the commodity produced, the farm storage bin the product is placed into, the condition of that storage bin (i.e., empty or full), and what other products are or were in that storage bin since the last time it was cleaned. The farmer retains and maintains these documents and can establish certain facts about a given lot, if requested. Likewise, intermediate storage facilities and transporters of the commodity sometimes generate and retain similar certification documentation, resulting in a very diverse and paper-intensive system that is not easily used to verify the status of a given lot. Furthermore, since participants along the chain maintain their own certification, there is a fair amount of variation in the marketplace.

In addition, each participant is likely to employ one or more customized enterprise software systems, such as accounting systems, inventory management systems, and enterprise resource planning (ERP) systems. These enterprise software systems are not designed for product traceability, and typically do not collect all of the data needed for product identity preservation.

### SUMMARY

In general, the invention provides techniques for preserving and tracing product origins and attributes. In particular, a system facilitator establishes a network-based lot tracking system that is accessible by each of the participants along the supply chain of a given product. As each participant handles the product, whether producing, harvesting, transporting or storing the product, that participant provides and updates information about the product moving through the entire supply chain.

Furthermore, the system collects integrates data from a variety of enterprise software systems. In particular, an integration module collects normalized data from each of the enterprise software systems and enters this data into a tracking system database. The presence of the integration module reduces duplicate data entry because an employee entering data in an enterprise software system of one unit does not need to reenter similar data in the tracking system.

In one embodiment, the invention is directed to a method comprising receiving with an integration module data from one or more enterprise software systems. The method further comprises applying a data definition to the data with the integration module to verify that the data complies with requirements of an identity preservation system. Next, the method call for recording the data to the identity preservation system upon verification of the data.

In another embodiment, the invention is directed to a system comprising a plurality of enterprise software systems, each of which collects business activity data and produces product tracking data from at least a portion of the collected business activity data. In addition, the system includes a product identity preservation system having an integration module, wherein the integration module that receives the product tracking data from the enterprise software systems and stores the product tracking data into the product identity preservation system.

In another embodiment, the invention is directed to a computer-readable medium comprising instructions. The instructions cause a programmable processor to receive with an integration module data from one or more enterprise software systems. The instructions cause the processor to apply a data definition to the data with the integration module to verify that the data complies with requirements of an identity preservation system. The instructions further cause the processor to record the data to the identity preservation system upon verification of the data.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a network communication system that facilitates communication and commercial transactions through a lot tracking system.

FIG. 2 is a block diagram illustrating an example lot tracking system for tracking the production and shipment of product that may be commingled.

FIG. 3 is a flowchart illustrating the basic operation of a lot tracking system consistent with the embodiments of the present invention.

FIG. 4 is a block diagram illustrating the production, transportation and storage of a product that is tracked by a lot tracking system.

FIG. 5 is a flow chart illustrating an example operation of a lot tracking system consistent with the embodiments of the invention.

FIG. 6 is a flowchart illustrating an example operation of identifying the condition of a storage location.

FIG. 7 illustrates a flow chart of an example lot tracing process.

FIGS. 8A-8D illustrate an example trace report generated as a compilation of a lot's history.

FIG. 9 is a flow chart illustrating an example operation of generating a test or audit.

FIG. 10 is a schematic representation of a database table used to track the movements of identified lots.

FIG. 11 is a schematic illustration of a lot identification database table.

FIGS. 12-23 illustrate exemplary interfaces for accessing and utilizing the tracking system of the invention.

FIG. 24 is a block diagram that illustrates a programmable computing system that provides an operating environment suitable for implementing embodiments of the invention.

FIG. 25 is a block diagram illustrating an exemplary embodiment of a tracking system that integrates data from a variety of enterprise software systems.

FIG. 26 is a flowchart illustrating an exemplary mode of operation for an embodiment of a tracking system having an integration module that integrates data from a variety of enterprise software systems.

FIG. 27 is a screen illustration of an exemplary user interface for reviewing business activities associated with the enterprise software systems.

FIG. 28 is a screen illustration of an exemplary user interface provided by the integration module for reviewing data fields of a business activity.

FIG. 29 is a screen illustration of an exemplary user interface provided by the integration module for reviewing relationship between business activities and database tables.

FIG. 30 is a screen illustration of an exemplary user interface provided by the integration module for reviewing a change history.

FIG. 31 is a screen illustration of an exemplary user interface provided by the integration module for editing data received from an enterprise software system.

### DETAILED DESCRIPTION

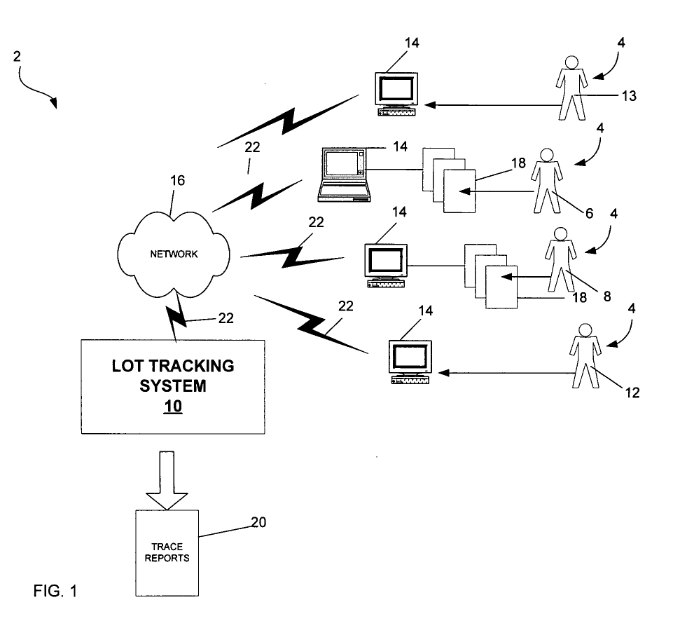

FIG. 1 is a block diagram illustrating a network communication system 2 that facilitates communication and commercial transactions between various parties, generally referred to as participants 4, and a lot tracking system 10. Participants 4 include producers 6 that grow or create various products and intermediaries 8 that receive the products for storage, processing, and/or transport. Customers 12 ultimately receive and use the products for some commercial purpose. Other participants 4 include internal or external business entities 13 that are linked with lot tracking system 10. Business entities 13 may be accounting departments or other data handling entities that are associated with a business controlling lot tracking system 10 or associated with one of the other participants 4. For example, an accounting department could automatically provide data to lot tracking system 10 dealing with the movement or disposition of various products.

Customers 12 utilize an appropriate remote device 14, such as a computer, telephone, PDA, or other suitable electronic device, to access lot tracking system 10 through a network 16, such as the Internet, via a communications link 22. Customer 12 accesses lot tracking system 10 and creates a “program” that specifies processes that should be followed in creating, transporting and storing the product. Producer 4 accesses lot tracking system 10 via remote device 14, reviews the program offered by customer 12 and accepts the program, thus generating a contract. Producer 4 grows, harvests and stores the product according to the terms of the program and transfers the product in a given quantity, referred to as a lot, to intermediary 8 for storage and/or transport. Each time the lot is moved and stored in a location, producer 4 or intermediary 8 accesses lot tracking system 10 and updates move data relating to the lot. In addition, the program may require that producer 4 or intermediary 8 provide particular certification documents 18 to lot tracking system 10, either by transferring an electronic document to lot tracking system 10 or indicating that a certification document has been generated. Customer 12 can access lot tracking system 10 and trace a given lot through the supply chain. Lot tracking system 10 determines each storage and transportation location the lot has been in and determines what, if any, other products were commingled with the lot. Lot tracking system 10 provides a trace report 20 that details the history of the lot. Trace report 20 may be generated by or displayed on remote device 14 with data provided by lot tracking system 10.

As indicated above, a lot is a quantity of a product moved or stored together. Lot tracking system 10 creates lot identification numbers, codes or other identifiers to identify specific lots. Lot tracking system 10 can use various schemas in defining the creation of a lot. For example, lot tracking system 10 generates (or is provided with) a lot identifier when the lot is initially formed. Thus, lot tracking system 10 can track and record each lot number so created throughout the entire process. Alternatively, each time two or more lots are stored or moved together, lot tracking system 10 generates a new lot identifier. As various lots are commingled, lot tracking system 10 can easily and succinctly track the contents. All of the information is retained and can be accessed. For example, assuming lot “10” comprises lots “4, 5, and 6”, lot tracking system 10 can determine the contents of lot “10” by recalling information pertaining to lots “4, 5, and 6” that is stored in memory. This approach simplifies the data management by not requiring a string of identifiers for commingled lots.

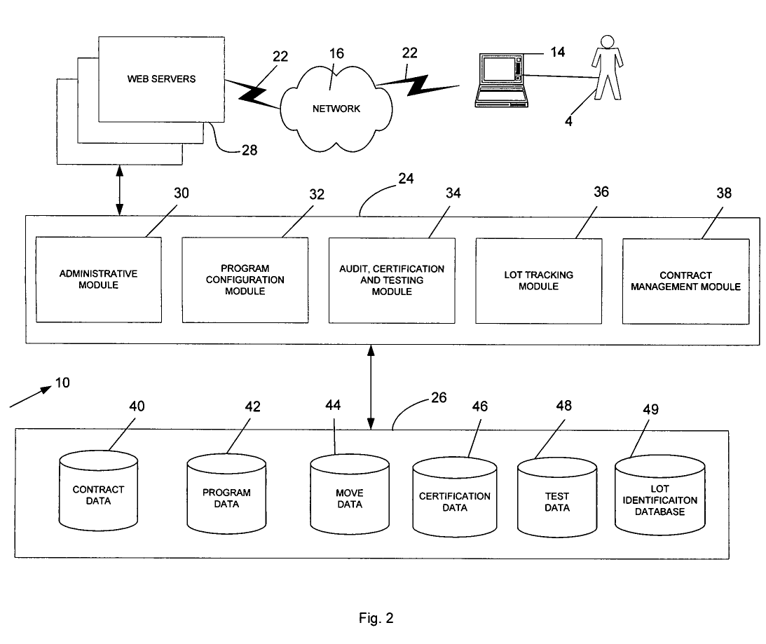

FIG. 2 is a block diagram illustrating an example lot tracking system 10 for tracking and tracing the production and shipment of product that may be commingled. In particular, lot tracking system 10 includes a software platform 24, executing on one or more computers (e.g., web or application servers), that is in communication with a database 26. In addition, participants 4 access software platform 24 through one or more web servers 28. Software platform 24 includes a number of software modules including an administrative module 38, a program configuration module 32, an audit, certification and testing module 34 (“audit module 34”), a lot tracking module 36 and a contract management module 38. Database 26, which is in communication with each of the modules 30-38, includes a contract database 40, a program database 42, a move database 44, a certification database 46, a test database 48, and a lot identification database 49.

A system facilitator establishes and maintains lot tracking system 10. The system facilitator accesses administrative module 30 to monitor and modify lot tracking system 10, including assigning rights and security levels to participants 4. Customer 12 utilizes program configuration module 32 to define the programs that are accessed by producer 6 and are stored in program database 42. Customer 12 (or other interested parties) utilizes lot tracking module 36 to trace and/or recall a lot based on information in move database 44. Producer 6 intermediary 8, and business entity 13 access audit module 36 and provide move, certification or test data relating to a given lot, which is then stored in move database 44. If a program requires the certification of certain actions or information, producer 6, intermediary 8 or business entity 13 provide the required certification information through audit module 34 and the certification information is stored in certification database 46. Producer 6 and customer 12 generate and ratify contracts through contract management module 38. Contract management module 38 stores and retrieves the contract data from contract database 40.

Thus, there are a number of ways for participants 4 to enter information into lot tracking system 10 through audit module 34. For example, producers 6 and intermediaries 8 supply their own information, which may include self certification. Independent third party auditors may observe and inspect the locations and procedures of producers 6 and intermediaries 8 and report and/or certify this information through audit module 34. Business entities 13 may supply data indicating a move or other disposition. Finally, various testing facilities may supply test results and other data to lot tracking system 10 through audit module 34.

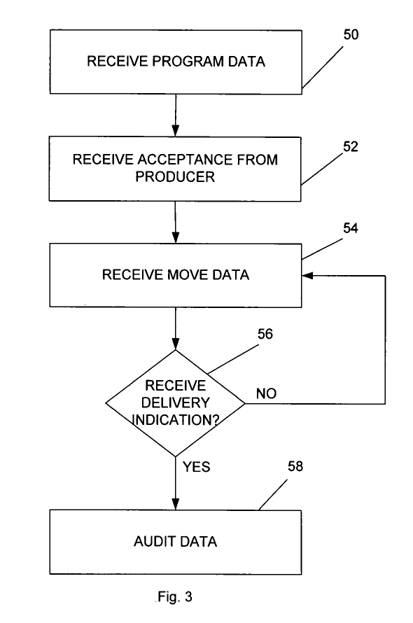

FIG. 3 is a flowchart illustrating the basic operation of lot tracking system 10. Referring to FIGS. 2 and 3, lot tracking system 10 receives program data (50) from customer 12. For example, customer 12 may want 10,000 bushels of conventionally developed #2 yellow corn delivered to a specific location. Customer 12 defines the order and the program requirements through program configuration module 32. To help producer 6 and intermediary 8 manage the program requirements, customer 12 may also define checklists for handling the product. The checklist can include each action that producer 6 and intermediary 9 must follow and may also indicate which certifications must be provided.

Lot tracking system 10 then receives (52) an acceptance of the program by producer 6 and generates a contract through contract management module 38. Producer 6 stores and/or moves lots of the product and lot tracking system 10 receives data (54) identifying the lot, the transportation or storage location, and the status of that location and stores this information in move database 44. Ultimately, the product is delivered to customer 12 and lot tracking system 10 receives data indicating delivery to customer 12 (50). If the received move data indicates handling by producer 6 or intermediary 8, lot tracking system 10 will again receive move data (54). At any point, customer 12 can access lot tracking system 10 and determine a lot's history (58). Customer 12 can, for example, identify any other crops that have been commingled with the lot in question.

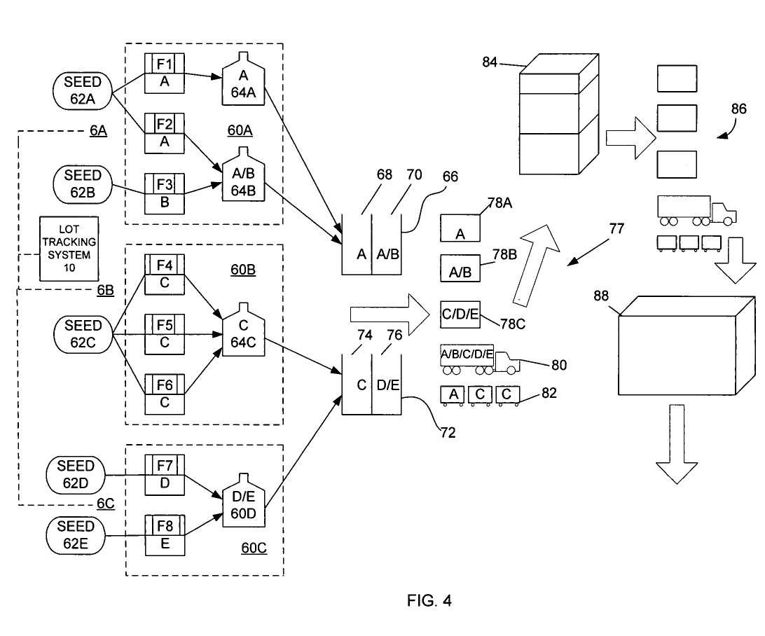

By way of example, FIG. 4 illustrates operation of lot tracking system 10 during the production of one or more commodities, the transportation of those commodities to various intermediate storage facilities, and the delivery of those commodities to customers 12.

More specifically, farms 60A, 60B, and 60C (collectively farms 60) have a number of fields F1-F8, where a given crop A,B,C,D or E is grown from corresponding seed types 62A, 62 B, 62C, 62D, 62E. For example, crops A, B, C, D and E may include grain, corn, soy beans or any number of other crops. Producer 6 obtains crop information (i.e., yellow corn) from seed distributors based on the selected seed 62 for the desired crop A-E. The crop information may describe, for example, the various attributes of seed 62, such as whether seed 62 is bio-engineered or conventionally developed. In addition, producer 6 may retain specific information about the particular characteristics of each field F1-F7 that may affect the resultant crop. Examples of field-specific information include an identification of the crops previously planted, the fertilizers used, adjacent crops, and the like. Producer 6A enters this information through lot tracking module 36 (FIG. 2) and the information is stored in lot identification database 49.

Producers 6 store harvested crops A-E in farm bins 64A, 64B, 64C, 64D, which are local storage facilities maintained on farms 60. Over time, producers 6 empty and fill each farm bin repeatedly. Prior to storing a new crop in bin 64, producer 6 may clean bin 64 or simply store the old and new crops together, causing them to become commingled and contaminating the new crop with the old one. For example, a producer 6A grows crop A on field F1, then stores crop A in clean bin 64A. Producer 6A then delivers crop A to bin 68 of elevator 66. Thus, crop A has been delivered to elevator 66 without having been commingled with any other crops. Producer 6A also harvests crop A and crop B from fields F2 and F3, respectively, and stores them together in farm bin 64B. This may or may not be significant, depending upon the characteristics of crops A and B. If, for example, crops A and B are both organically produced #2 yellow corn, the fact that they have been commingled may not be important. However, if crop A has been organically produced and crop B has not been, the commingling of the two together may be significant to certain customers 12.

Similarly, producer 6B grows and harvests crop C on fields F4-F6 of farm 60B and stores the harvested crop in farm bin 64C. Producer 6B may have earlier stored a bio-engineered crop in farm bin 64C. Assuming crop C has been conventionally developed and farm bin 64C was not cleaned prior to the introduction of crop C, the bio-engineered crop contaminates crop C when the two crops are commingled. That is, a farm bin should be both empty and clean to avoid contaminating subsequently added crops. For example, even if a farm bin is empty but has not been cleaned, trace components remaining in the farm bin will contaminate any crops that are subsequently added. Regardless, producer 6B knows the status of farm bin 64C prior to the introduction of crop C and provides this information to lot tracking system 10 through lot tracking module 36.

If two different lots of two different crops (e.g., high protein corn and corn with standard protein levels) mix together during storage or transport, a new lot is effectively created and lot tracking system 10 tracks both the new combination and the original lots with a single lot identifier. Thus, each time a lot moves, certain information should be retained and provided to lot tracking system 10. For example, the condition of the storage location or transportation device should be noted; that is, is it empty or full, clean or unclean? If clean and empty, a lot added thereto will remain intact. If partially full or if empty but unclean, producer 6 should record the nature of the previously stored lots or lot tracking system 10 automatically identifies the previously stored lots from data stored in move database 44.

Generally, each of the transportation and storage locations receive lots from many different producers. By way of example, producer 6A delivers crops A and B, stored together in farm bin 64B, to elevator 66 and stores previously commingled crops A and B together in bin 70 and stores crop A alone in bin 68. Similarly, crop C moves to bin 74 of elevator 72 and commingled crops D and E move into bin 76. At this point, crops A-E are out of the possession and control of the producers 6 who harvested and initially stored them. Intermediaries 8, in this case elevator operators, rely on information provided by producers 6 to identify the characteristics of the lots they are receiving. Similarly, the elevator operators know the status and condition of their bins 68, 70, 74 and 76 as new lots are received. Intermediaries 8 provide this information to lot tracking system 10.

At some point, the elevator operators transport all or part of the contents of elevator bins 66, 72 to an intermediate storage facility 84, such as a warehouse or similar structure. The elevator operators use a variety of transportation devices 77 including barges 78A, 78B, and 78C, truck 80, train 82 or various other known transportation methods. For example, crop A moves from bin 68 onto barge 78A. Assuming farm bin 64A, elevator bin 68, and barge 78A were all clean and empty, the lot now carried by barge 78A only contains crop A. Barge 78C now contains a lot that includes crops C, D and E and truck 80 has a lot that contains crops A, B, C, D and E. Thus, any customer 12 that wants information about the lot of truck 80 will need to be aware of crops A, B, C, D and E, including their storage history, the field they were grown in, the seeds used, etc. Of course, only these five crops are illustrated. Many of these storage facilities could have received any number of crops from any number of sources and a given lot could be an accumulation of a great number of different crops.

Transportation devices 77 move the lots to intermediate storage facility 84 where they are stored either as separate lots or commingled together, depending upon the characteristics of intermediate storage facility 84. Intermediate storage facility 84 then delivers the products (in the same or different lot configurations) to customer facility 88 via transportation devices 86. Each time a lot is moved, participant 4 provides information to lot tracking system 10 indicating whether the location the lot is being moved to is clean and empty and if not, what lots were there since that location's last reported clean and empty status. Alternatively, lot tracking system 10 can determine which lots were there previously based on information retained in database 24.

Customer 12 can access lot tracking system 10 to obtain information about the histories of the received lots. In addition, customer 12 may use the received crops to make other products that are sold to consumers, and could also utilize the lot tracking system for further processed products and consumer goods. Consumers could also access lot tracking system 10 to determine the history of a given product. For example, a given box of cereal could have an indication of the lots used by a manufacturer in making the product. The consumer could access lot tracking system 10 and determine the nature of the grain used.

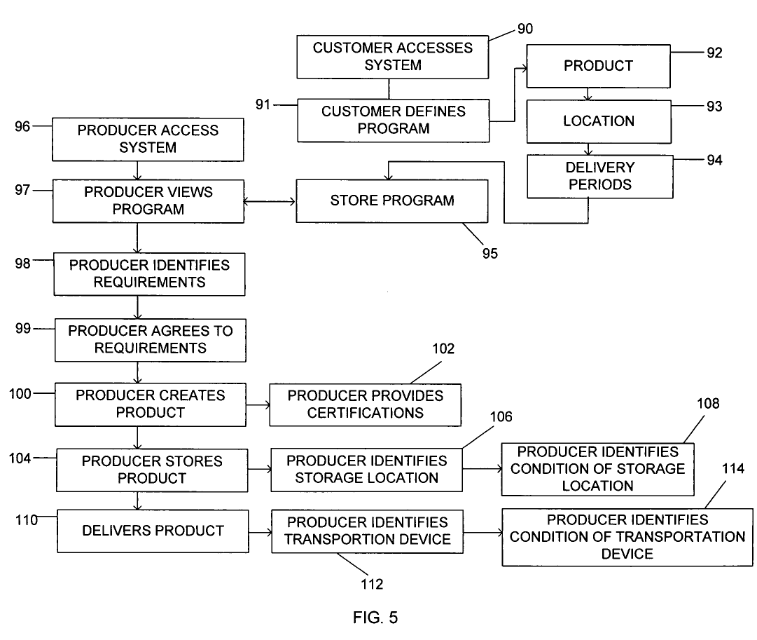

FIG. 5 is a flow chart illustrating an example operation of lot tracking system 10. Referring to FIGS. 1, 2 and 5, customer 12 accesses (90) lot tracking system 10 through remote device 14 and accesses program configuration module 32 to define a program (91) that includes defining a desired type and quantity of a product (92), desired parameters for intermediate storage locations (93), a final destination, and the desired transportation parameters (94). As used herein, the term “program” refers to the parameters that customer 12 creates that relate to the purchase, delivery, handling, processing, and/or any other disposition of a product for customer 12. Customer 12 defines the requirements for each parameter and may also define the actions required for certifying a defined parameter. Customer 12 may set forth the parameters in checklists that are available through lot tracking system 10. For example, customer 12 may define a program that requires producer 6 or intermediary 8 to certify each transportation device as clean and empty and, if not, precisely provide information describing the other lots that are present. This may also be accomplished automatically via other aspects of lot tracking system 10. Furthermore, customer 12 may require producer 6 or intermediary 8 to prepare, sign, scan and/or transmit a specific document to lot tracking system 10 in order to fully comply with the certification requirement. Once created, the program is stored (95) in lot tracking system 10 and is accessible by various producers 6 who may be able to fill the order.

Producer 6 accesses (96) lot tracking system 10 through contract management module 38 and views (97) the programs generated by customers 12. In viewing the program, producer 6 takes note of the specific requirements (98) being made by customer 12. If the requirements are acceptable, producer 6 agrees to fulfill an order made for customer 12 and a contract is generated (99). Contract management module 38 may generate the contract automatically if producer 6 and customer 12 have provided sufficient information and have authorized lot tracking system 10 to generate the contract.

When defining the program, customer 12 also utilizes contract management module 38 to help define the contract. The contract may specify, among other things, a quantity of a desired product to be delivered, the specific characteristics of that product, and the desired delivery locations. Once a program defines a contract, contract management module 38 monitors the status of that contract and allows customer 12 to view the status of the contract. That is, contract management module 38 regulates the allotment of contracts among producers 6 so that contracts are not generated for amounts in excess of the amounts allocated within the program. For example, if a given customer's 12 program is short by 10,000 tons of grain, contract management module will not allow producer 6 to generate a contract for 15,000 tons. Furthermore, customer 12 can access lot tracking system 10 though contract management module 38 and determine how much of the program has been contracted for, filled, and/or delivered.

Producer 6 grows and harvests the product (100) according to the agreed upon terms. If required, producer 6 provides certifications (102) to lot tracking system 10. For example, producer 6 might certify that a specific seed was utilized or that particular fertilizers were used on a given field. Producer 6 transmits this information to the lot tracking system 10, either in the form of an electronic or digital document, or simply indicates that certifications have been made and are being retained.

Producer 6 may store the product locally (104), and identifies the particular storage location (106) and corresponding condition (108) to lot tracking system 10. Producer 6 then delivers the product (110) to intermediary 8, usually an elevator, where the product is purchased from producer 6. At this point, producer 6 identifies the transportation device (112) and its condition (114) to lot tracking system 10. From this point until the product reaches its destination, a given lot will follow the same sequence. That is, the lot is moved and stored with the identification and condition of each transportation device or storage location being delivered to lot tracking system 10 along with an identification of the particular lot. The indication of the condition usually includes an indication of whether or not the storage or transportation device is clean and empty. Participants 4 provide certifications 18 at each step as required by the defined program established by customer 12.

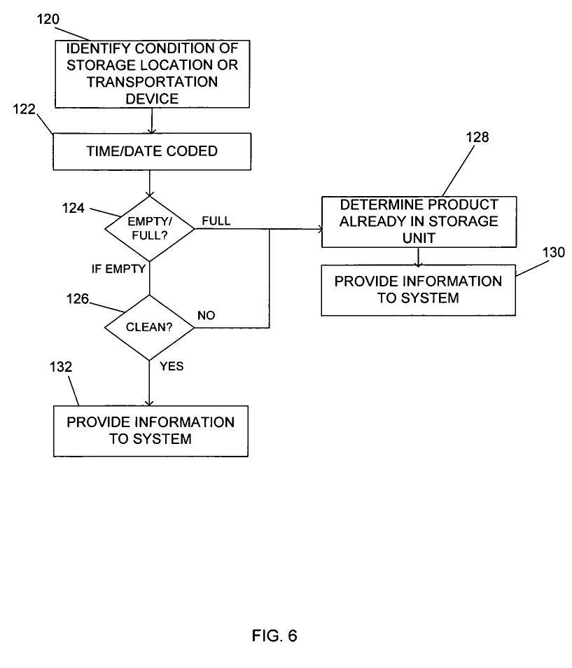

FIG. 6 is a flowchart illustrating an example operation of identifying the condition of a storage location or transportation device (120) to lot tracking system 10. Participant 4 communicates with lot tracking system 10 and identifies a particular lot. The communication is time and date coded (122) or time and date information is manually provided. Participant 4 inspects the storage location or transportation device and determines its condition and reports the condition to lot tracking system 10. More specifically, participant 4 indicates whether the storage location or transportation device is empty or is already full (or partially full) of a product (124). If the storage location is empty, participant 4 then indicates whether the storage location or transportation device is clean (126). That is, the contents of a given storage location or transportation device could have been completely removed thus making it empty; however, without actually cleaning that storage location subsequently added product will commingle with the remaining residue. Therefore, participant 4 determines either that the storage location is full (124) or is empty but not clean (126), then participant 4 may determine which product or products are already present (128) in the storage location and this information is provided to lot tracking system 10 (130).

Alternatively, participant 4 may only provide an indication that the storage location or transportation device is not clean and lot tracking system 10 determines from move database 44 which other products are present. Likewise, if the storage location or transportation device is clean and empty, this information is provided to lot tracking system 10 (132). As another alternative, the clean and empty status can be made in a single indication. That is, participant 4 simply indicates whether the location is clean/empty or not clean/empty. In other words, clean and empty can effectively be the same, single status thus reducing the amount of information that participant 4 is required to provide.

One advantage of the invention is the ability to track a lot and determine its history over a potentially complex transportation and storage process. That is, by accessing lot tracking system 10 participant 4 can determine what a given lot has been stored and transported with, how that lot was grown, and what it was grown from, among other things. One potential issue of concern is whether a given lot is a bio-engineered product or conventionally developed, and if it is a bio-engineered product, whether it has ever been stored or transported with a conventionally developed product. Of course, various other issues may be of concern and could be similarly determined from a trace of a given product. For example, certain parties may wish to know whether a product is organically produced or whether a product contains certain desirable attributes or not.

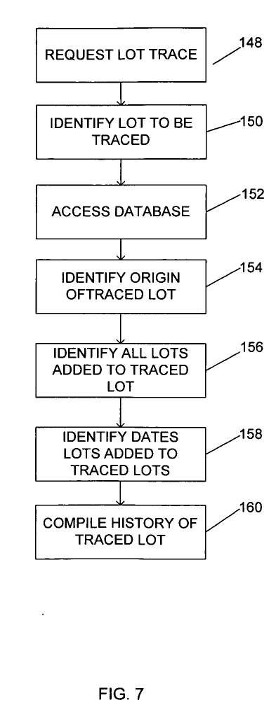

FIG. 7 illustrates a flow chart of an example lot tracing process. Participant 4, and most commonly customer 12, accesses lot tracking system 10 through lot tracking module 36 and requests the tracing of a lot (148). Participant 4 provides an identification of the lot to be traced (150), which could be a lot identification code or an indication of a storage location or transportation device along with a time and date indication. Available lots, storage locations, and transportation devices are all searchable and selectable. In other words, there are various ways to identify a given lot of a product to lot tracking system 10. Once a given lot is identified (150), lot tracking system 10 accesses (152) move database 44 and identifies the origin of the searched lot (154). Lot tracking system 10 identifies all other lots that have been added to the searched lot (156) as well as the times and dates they were commingled (158) and a history of the lot is compiled (160) and provided to participant 4.

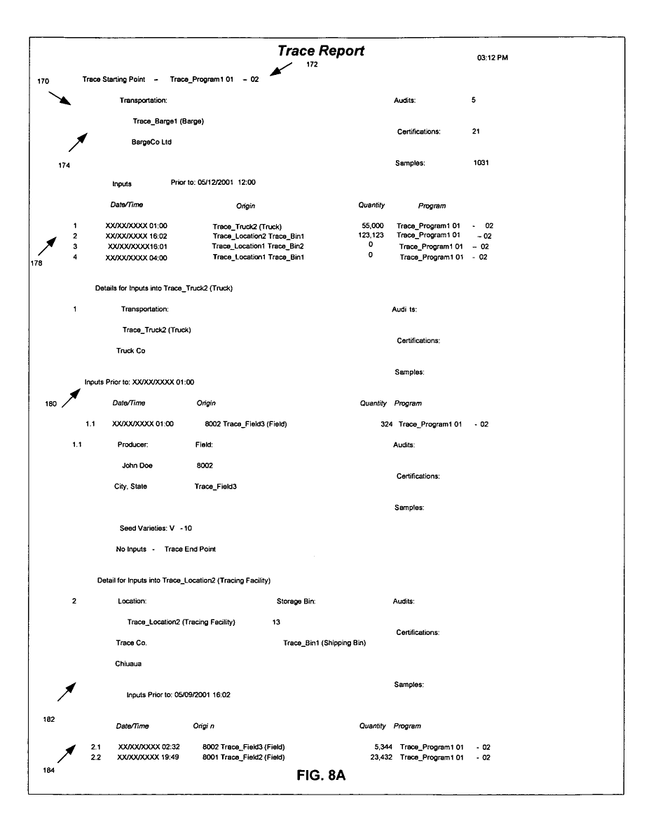

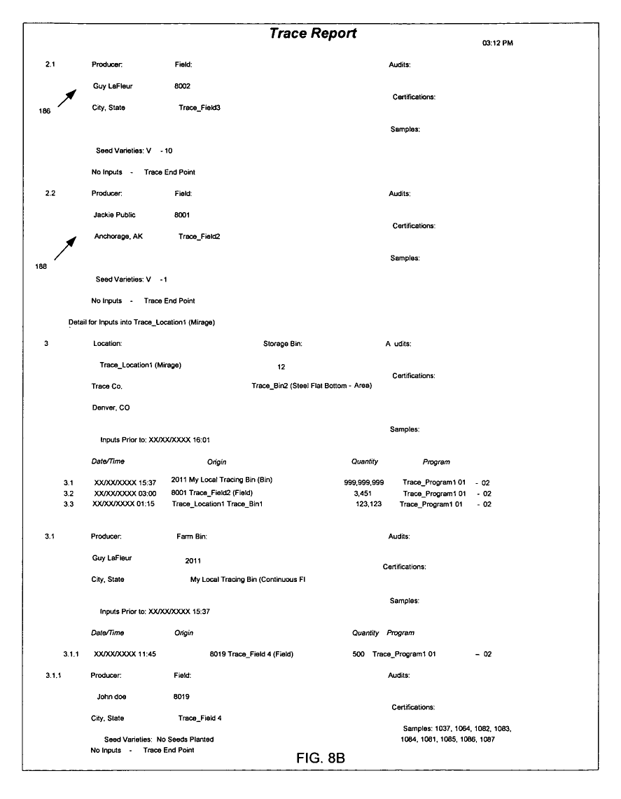

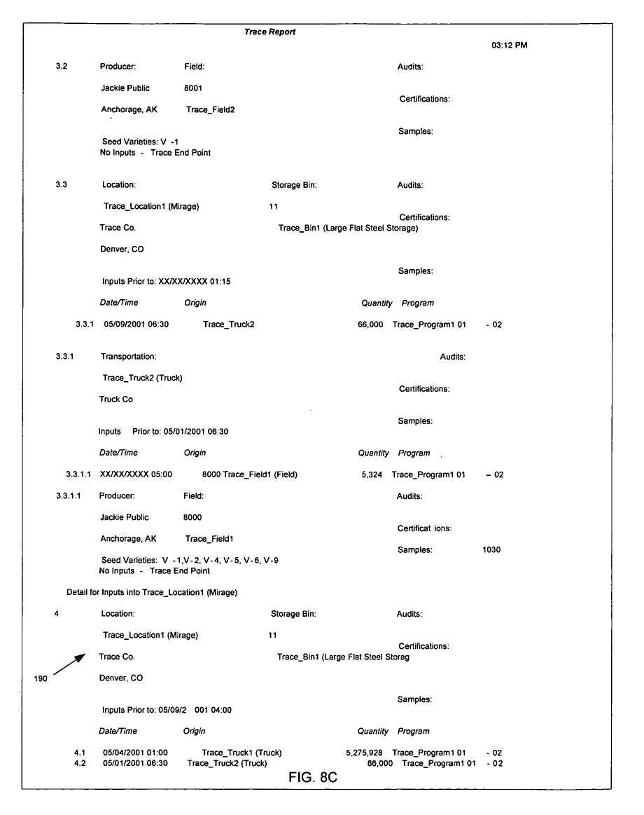

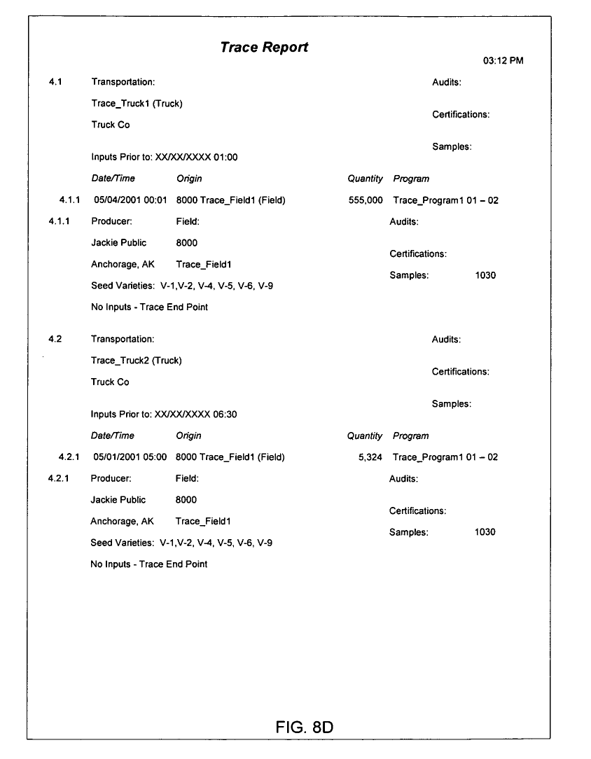

FIGS. 8A-8D illustrate an example trace report 170 that could be generated as a compilation of a lot's history. Trace report 170 includes a lot identification code 172 and a summary of the lot history 174. Summary 174 includes an identification of the lot's current location 176, which is listed as Barge 1. A listing of all previous storage and transportation locations is summarily provided at 178, and each of these is numerically coded. For example, “1” indicates that the lot was in Truck 2, while “4” indicates the lot was in location 1, bin 1.

In addition, trace report 170 breaks down each location 178 noted in summary 174 into more detail. For example, section 180 refers to transportation device “1”, which is Truck 2. More information about Truck 2, such as its owner and operator may be provided. Under section 1.1, previous inputs are listed. These are other products that have been commingled with the traced lot. In this example, a product has been commingled with the traced lot in Truck 2. The commingled product was produced by “John Doe” on his field “8002” from seed variety “V-10”. If desired, this field, producer, lot or seed variety could be traced as well.

The next previous storage location is designated “2” and is detailed at 182. Specifically, storage location “2” refers to location 2, bin 1 which is actually bin 13 of the “Chiuaua” Company's storage location. Section 184 summarizes the two other products that the traced lot was commingled with at this location. Specifically, products from fields 8001 and 8002 (fields 2 and 3, respectively) were added to the traced lot at this location. Section 186 provides further information on field 8002 and section 188 provides further information on field 8001. Trace report 170 provides this type of information for each storage and transportation location. Trace report 170 ends with the initial production of the traced lot. That is, location “4” is the farm bin the product was initially stored in after harvesting and is detailed in section 190. Under heading 4.2.1, section 190 indicates that “5,324” bushels of the product were taken from field 8000 on May 1, 2001 and were grown from seed varieties “V-1, V-2, V-4, V-5, V-6, and V-9.” In addition, a sample was collected and is stored with an identification of “1030.” The producer may store the sample or send it to a central repository maintained in conjunction with lot tracking system 10. Section 190 also indicates that an additional “555,000” bushels were taken from the same field and stored on May 4, 2001. Thus, even though they are the same product, grown from the same seeds on the same field, these different lots are noted just in case anything was done to the product between harvesting the lots that would be relevant to customer 12.

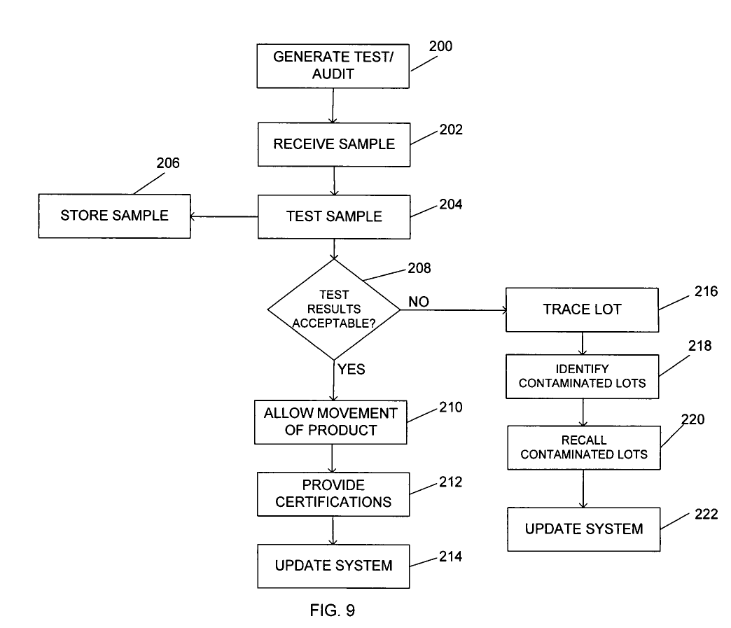

FIG. 9 is a flow chart illustrating an example operation of lot tracking system 10 when generating a test or audit (200). Such a test or audit can be done for a variety of reasons. For one, testing could be a standard practice of a given intermediary 8, a requirement of a given program as defined by customer 12, or intermittently requested by various parties. Once initiated, a sample is collected and sent to a testing facility (202). The sample collectors could promptly send the sample in or they could hold the sample for some period of time before submitting it, depending upon the program. Then, the testing facility tests the sample (204) for any number of characteristics and stores the sample (206). The testing facility provides the results (208) to lot tracking system 10 as well as any interested party. If the sampled lot is still moving through the supply chain, it is allowed to continue (210), any required certifications are generated (212), and lot tracking system 10 appropriately updates (214) the information. Participants 4 provide an indication that the test occurred, provide the results of the testing, and provide either an indication of the certification or the actual certification to lot tracking system 10. Independent third parties observe the locations and/or procedures of various participants 4 and either report or certify those actions through audit module 34.

If the test results are unacceptable (208), then lot tracking system 10 traces the lot (216) to determine (218) which other lots have been affected by the unacceptable lot. If appropriate, lot tracking system 10 recalls the contaminated lots (220) or provides an indication of their condition. Lot tracking system 10 again updates the information (222).

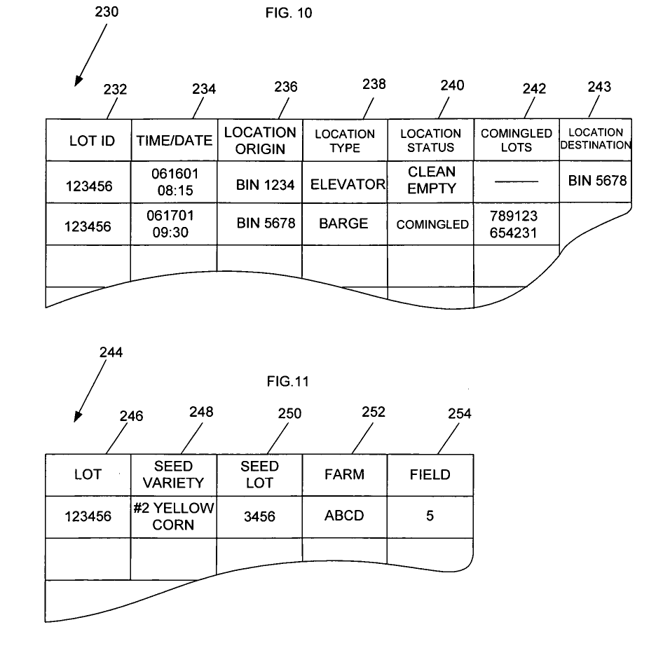

FIG. 10 is a schematic representation of a database table 230 used to track the movements of identified lots. Lot tracking system 10 can use various methodologies to track lots, their status, and an identification of commingled products. By way of example, database table 230 is a move table. That is, lots are uniquely identified and each time a lot moves, that move is time stamped and entered into database table 230. Thus, by knowing where a given lot is and for how long, along with an indication of any other lot(s) are already present or subsequently added, lot tracking system 10 can determine a complete history. Database table 230 includes an entry for lot identification 232, a time/date index 234, a location origin entry 236, and a location destination entry 243. From this information, lot tracking system 10 can generate a lot history based on the entries of database table 230. Additional information can be stored in database table 230 for convenience, such as a location type entry 238, a location status entry 240 such as clean, empty, etc., and an identification of commingled lots 242.

FIG. 11 is a schematic illustration of a lot identification database table 244. While database table 230 of FIG. 10 could store all the necessary data, lot identification database table 244 illustrates how additional data can be stored either separately (as illustrated) or with database table 230. Lot identification database table 244 includes a lot identifier entry 246, a seed variety entry 248, a seed lot entry 250, a farm identification entry 252, and a field identification entry 254.

Lot tracking system 10 tracks a variety of grown products that may be commingled through storage and transportation. Furthermore, lot tracking system 10 can also track the products even after they have been processed or otherwise transformed. For example, lot tracking system 10 tracks lots of soybeans as they are moved, stored and potentially commingled. After receiving a lot of soybeans, customer 12 may process the soybeans into a product such as soybean meal or soymilk. The soybean meal or soy milk is then distributed through commerce, but can still be tracked in the same way by lot tracking system 10 so that interested parties can ascertain the composition of the products received.

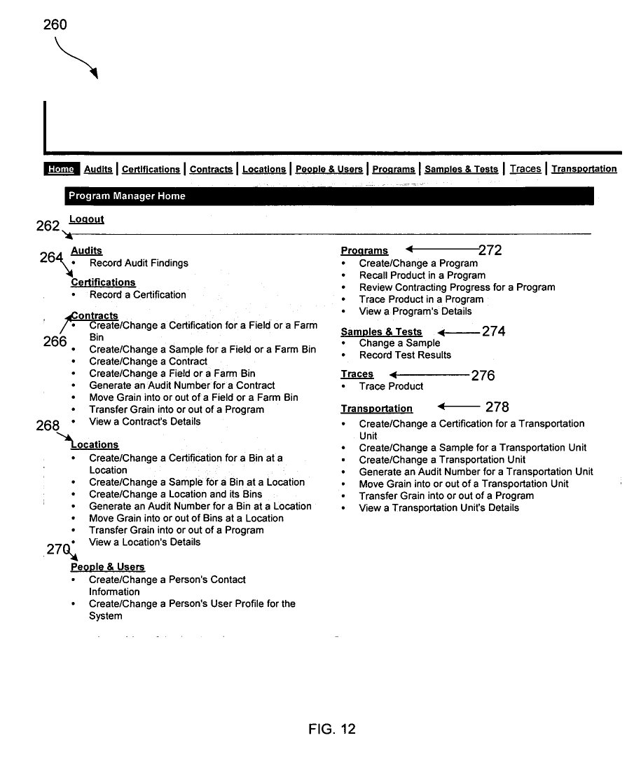

In one embodiment, lot tracking system 10 is implemented on one or more servers hosting HTML (hypertext markup language) based Web pages that are accessible via the Internet, and specifically through the World Wide Web (“the Web” or “WWW”). The Web pages provide a platform and protocol through which producers 6, intermediaries 8, customers 12, consumers or any other participants 4 access lot tracking system 10 and either obtain or provide information. FIG. 12 illustrates an example interface 260 by which an authorized customer 12 defines a program. Interface 260 refers to the authorized customers 12 as program managers. Only customers 12 i.e., program managers, have access to interface 260. Other users access lot tracking system 10 through other interfaces (not illustrated) that are appropriate for a given participant depending upon their role in the supply chain.

Interface 260 provides a gateway through which customer 12 defines programs and obtains and provides information. For example, audit link 262 allows customer 12 to generate an audit and record audit findings. Certification link 264 allows customer 12 to view and record certifications. Contract link 266 allows customer 12 to create and modify contracts that provided to producers for various quantities of a given product. Location link 268 and transportation links 278 provide customer 12 the option of defining specific storage locations and transportation devices as well as the various requirements for using those storage locations and transportation devices, at least with respect to that customer 12. A people and user's link 270 allows for the customization of personal information for various participants 4. Programs link 272 allows customer 12 to create and define specific programs for tracking lots. As explained above, the program defines the specific parameters that producers and handlers of the lots must follow to meet a programmer's criteria and accept a given programmer's contract. A trace link 276 allows a specifically identified lot to be traced and facilitates the generation of the appropriate reports. Finally, a samples and test link 274 allows customer 12 to record and modify sample information and requirements.

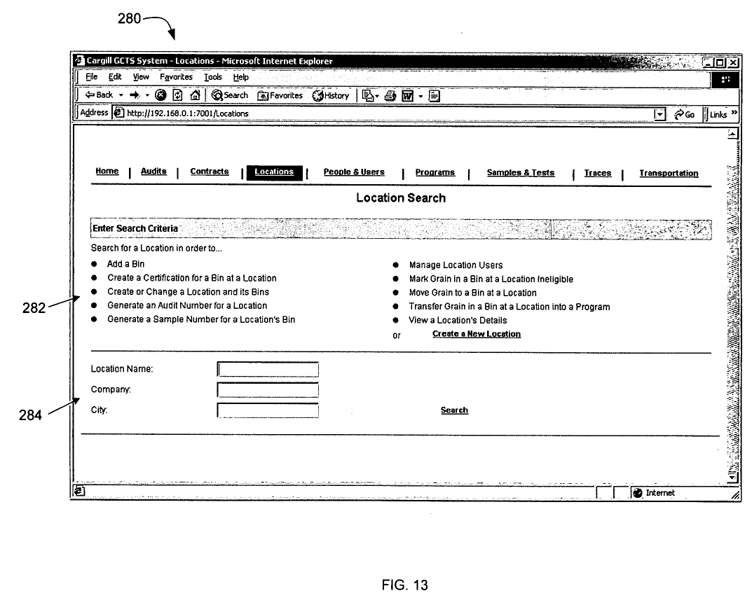

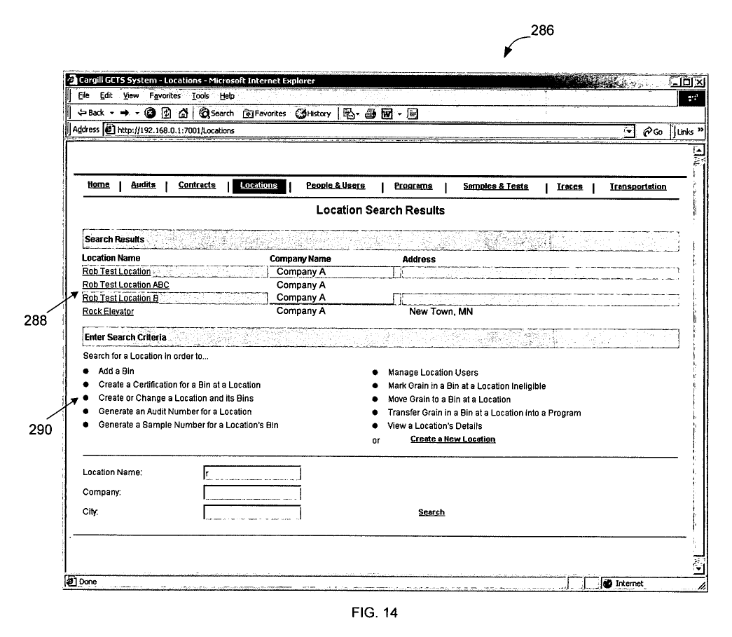

FIG. 13 illustrates an example interface 280 displayed by lot tracking system 10 when a participant 4 selects location link 268 of FIG. 12. Participant 4 selects a reason to view a given location from a list 282, then enters the appropriate search criteria or alternatively, participant 4 simply enters search criteria 284 directly. FIG. 14 illustrates an example interface 286 having example location results generated from a location search conducted through interface 280. A listing of locations 288 meeting the designated criteria and each of these locations could be selected to obtain additional information. Interface 286 also provides the same searching parameters 290 that were available with interface 280.

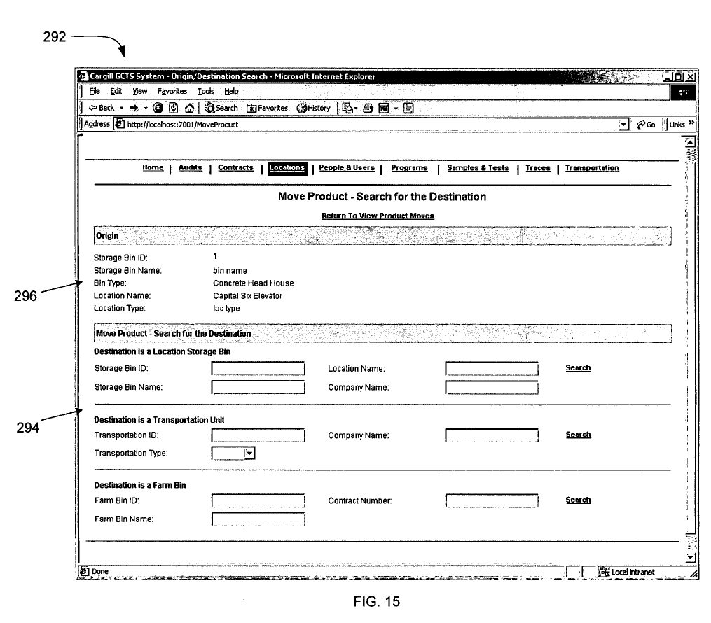

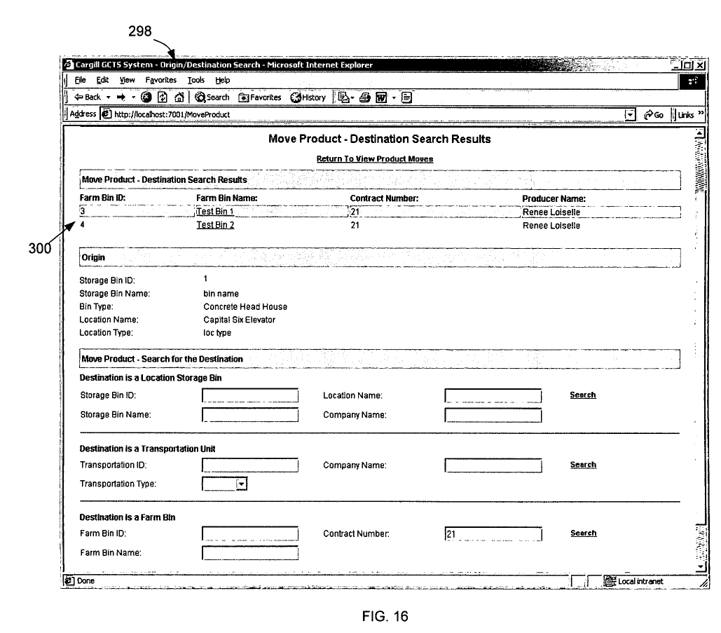

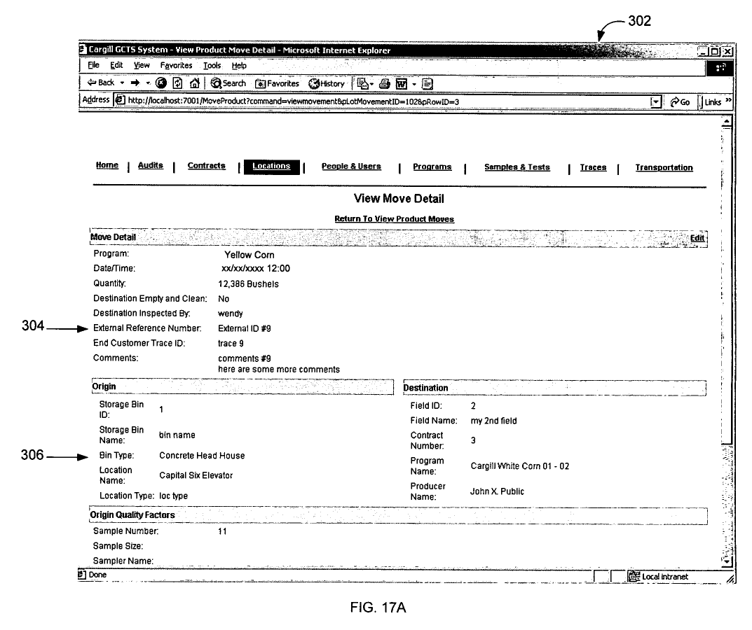

FIG. 15 illustrates an example interface 292 displaying an example move search format. Specifically, interface 292 allows participant 4 to search for destinations 294 when and origin 296 is known. Customer 12 utilizes a similar page to search for the origin 296. Destination choices 294 prompt participant 4 to enter criteria for the desired type of destination, i.e., storage bins, farms bins, or transportation units. FIG. 16 is an example interface 298 showing results obtained from searching page 292 with the desired destination being a storage bin. Interface 298 lists two possible destination bins 300.

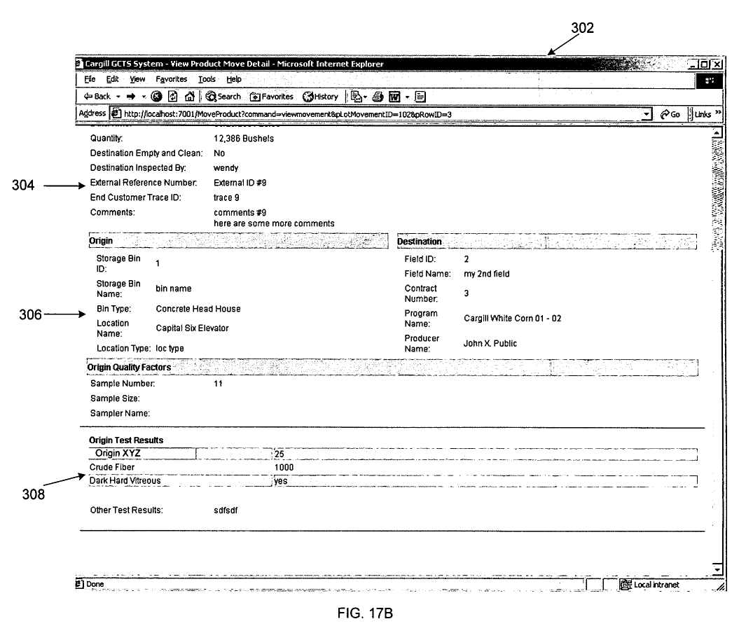

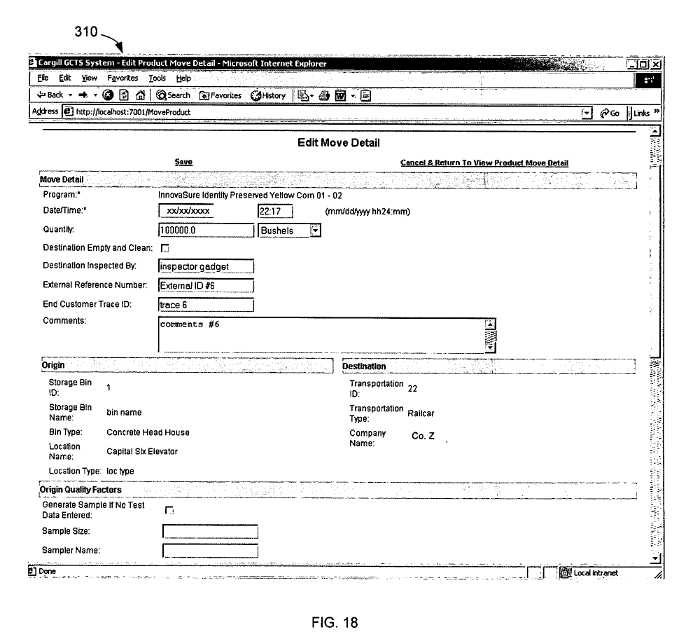

FIGS. 17A and 17B illustrate example interface 302 presenting move detail information. As illustrated, a move detail section 304 includes information about the relevant program, the time stamp, the status (i.e., clean/empty) of the destination, and tracking information. The origin and destination are indicated at 306 while the results of any testing done are displayed at 308. Interface 302 simply provides information, while example interface 310, illustrated in FIG. 18 allows participant 4 to edit move details and facilitates the entry or modification of move detail information.

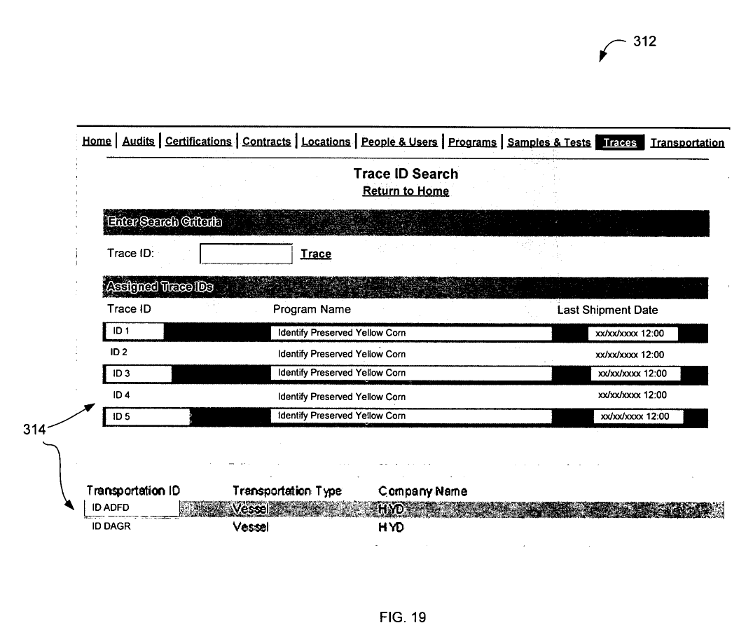

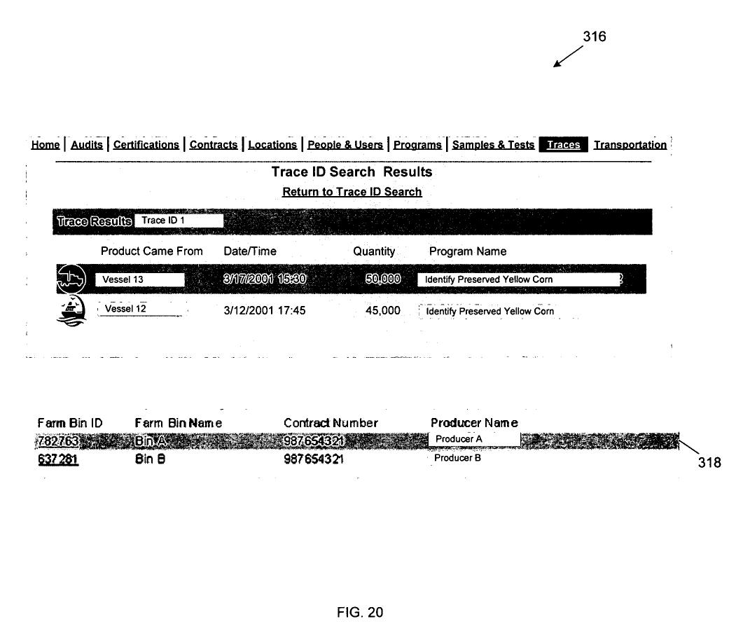

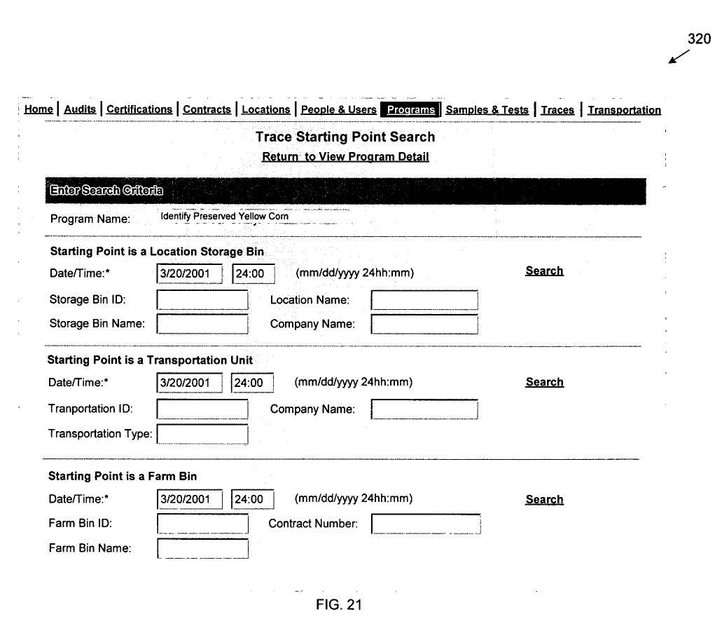

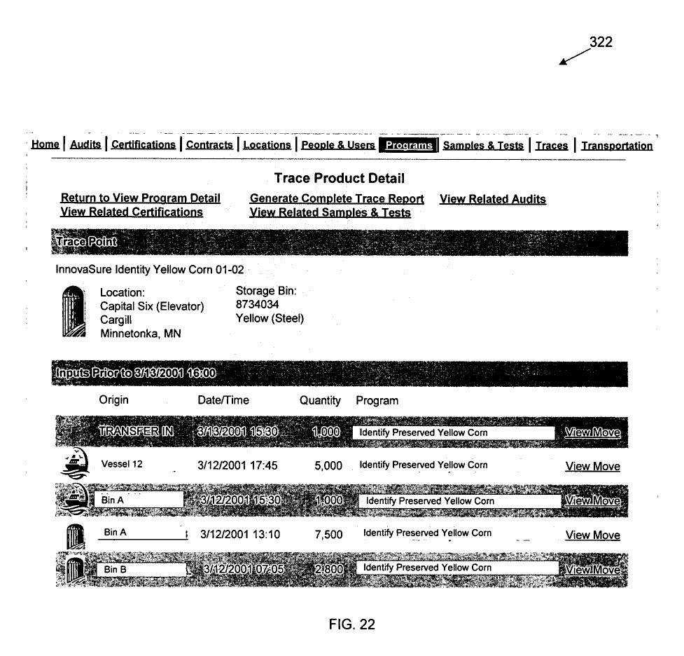

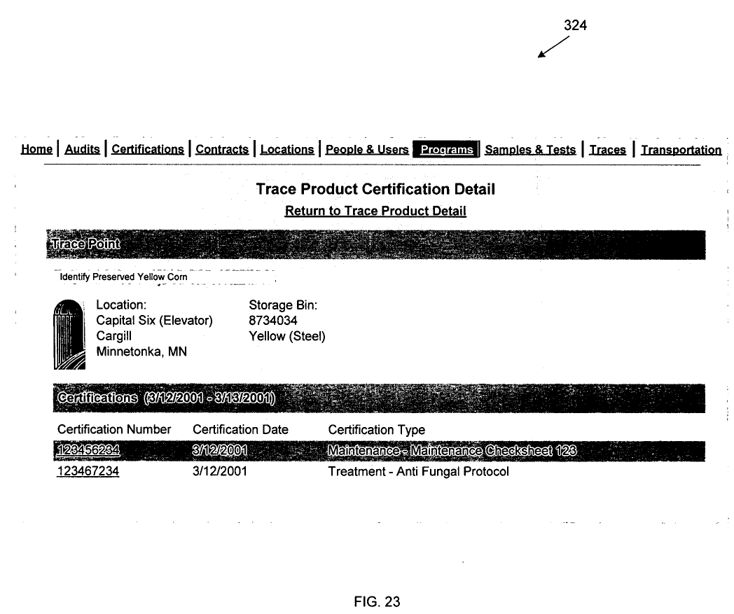

As explained above, various participants 4 often want to trace a given lot. FIG. 19 illustrates an example interface 312 presenting a trace search that allows participant 4 to trace previously identified lots 314. The desired previously identified lot is selected, in this case “ID 1”, and the results display on example interface 316 illustrated in FIG. 20, presenting sample search results. Interface 316 indicates where the products came from, when they were delivered, what quantity was delivered and the program name that the delivery was under. Example interface 318 illustrates the data fields that would result if the trace results lead to a farm bin as the source. Of course, selecting any of the listed sources will allow participant 4 to continue along the supply chain to the next previous source of product, (transportation unit, storage location or farm field). FIG. 21 illustrates a search page 320 that allows participant 4 to input various criteria in order to facilitate a trace where the starting point is not obtained from a list of previously identified lots 314. Within interface 320, participant 4 selects from various starting points, such as a storage bin, a transportation unit, or a farm bin. Participant 4 can search each of these criteria in various ways, such as by a specific identification number or code, a name or a company name. FIG. 22 illustrates an example interface 322 providing a sample report identifying all of the inputs into a selected location and FIG. 23 illustrates an example interface 324 presenting a sample report listing details about all of the certifications available for the inputs into the traced location.

While certain example interfaces have been illustrated, they are not meant to be all-inclusive or limiting. The same types of searching and reporting can be done in other formats. In addition, many of the features of lot tracking system 10 described herein will have additional screens that have not been illustrated herein.

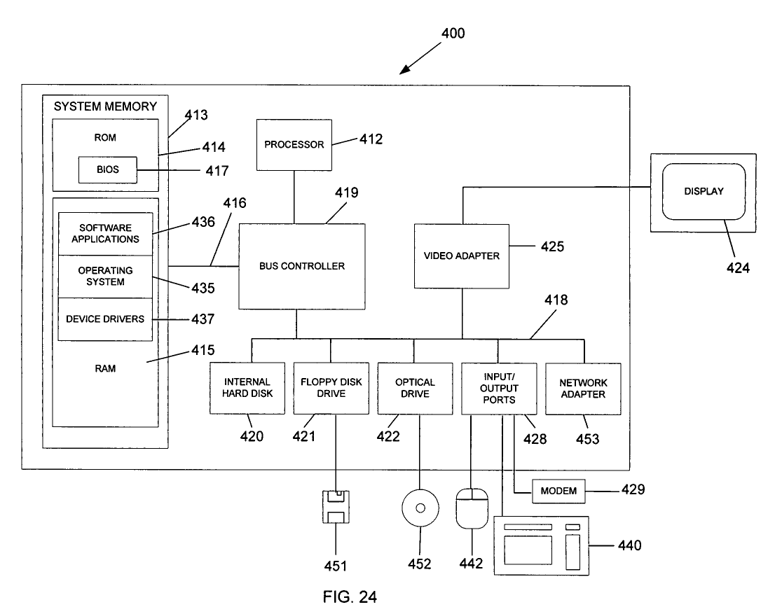

FIG. 24 illustrates a programmable computing system (system) 400 that provides an operating environment suitable for implementing the techniques described above. The system 400 includes a processor 412 that in one embodiment belongs to the PENTIUM® family of microprocessors manufactured by the Intel Corporation of Santa Clara, Calif. However, the invention can be implemented on computers based upon other microprocessors, such as the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. In various configurations, system 400 represents any server, personal computer, laptop or even a battery-powered, pocket-sized, mobile computer known as a hand-held PC or personal digital assistant (PDA).

System 400 includes system memory 413, including read only memory (ROM) 414 and random access memory (RAM) 415, which is connected to the processor 412 by a system data/address bus 416. ROM 414 represents any device that is primarily read-only including electrically erasable programmable read-only memory (EEPROM), flash memory, etc. RAM 415 represents any random access memory such as Synchronous Dynamic Random Access Memory.

Within the system 400, input/output bus 418 is connected to the data/address bus 416 via bus controller 419. In one embodiment, input/output bus 418 is implemented as a standard Peripheral Component Interconnect (PCI) bus. The bus controller 419 examines all signals from the processor 412 to route the signals to the appropriate bus. Signals between the processor 412 and the system memory 413 are merely passed through the bus controller 419. However, signals from the processor 412 intended for devices other than system memory 413 are routed onto the input/output bus 418.

Various devices are connected to the input/output bus 418 including hard disk drive 420, floppy drive 421 that is used to read floppy disk 451, and optical drive 422, such as a CD-ROM drive that is used to read an optical disk 452. The video display 424 or other kind of display device is connected to the input/output bus 418 via a video adapter 425.

Users enter commands and information into the system 400 by using a keyboard 440 and/or pointing device, such as a mouse 442, which are connected to bus 418 via input/output ports 428. Other types of pointing devices (not shown) include track pads, track balls, joysticks, data gloves, head trackers, and other devices suitable for positioning a cursor on the video display 424.

System 400 also includes a modem 429. Although illustrated as external to the system 400, those of ordinary skill in the art will quickly recognize that the modem 429 may also be internal to the system 400. Network interface 453 or modem 429 are typically used to communicate over a network (not shown), such as the global Internet, using either a wired or wireless connection.

Software applications 436 and data are typically stored via one of the memory storage devices, which may include the hard disk 420, floppy disk 451, CD-ROM 452 and are copied to RAM 415 for execution. In one embodiment, however, software applications 436 are stored in ROM 414 and are copied to RAM 415 for execution or are executed directly from ROM 414.

In general, the operating system 435 executes software applications 436 and carries out instructions issued by the user. For example, when the user wants to load a software application 436, the operating system 435 interprets the instruction and causes the processor 412 to load software application 436 into RAM 415 from either the hard disk 420 or the optical disk 452. Once one of the software applications 436 is loaded into the RAM 415, it can be used by the processor 412. In case of large software applications 436, processor 412 loads various portions of program modules into RAM 415 as needed. The Basic Input/Output System (BIOS) 417 for the system 400 is a set of basic executable routines that have conventionally helped to transfer information between the computing resources within the system 400.

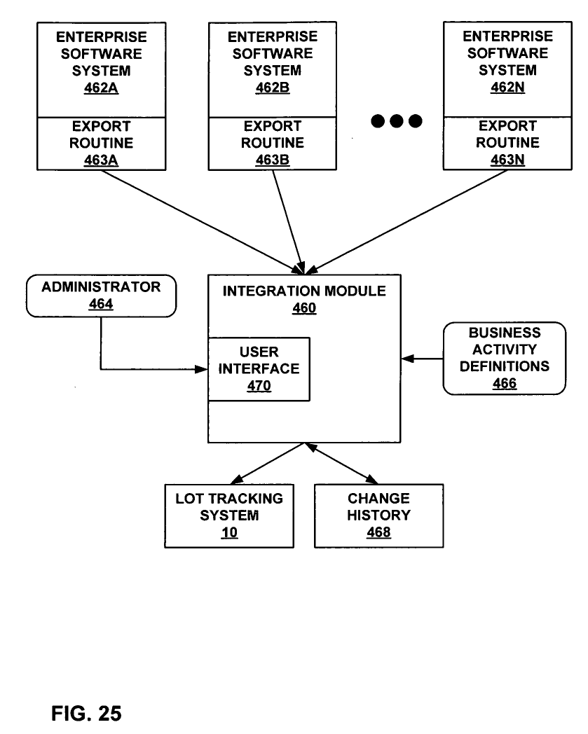

FIG. 25 is a block diagram illustrating an exemplary embodiment of a product identity preservation system that employs an integration module 460 to integrate data from enterprise software systems 462A-462N (collectively enterprise software systems 462). Enterprise software systems 462 may include various accounting systems, inventory management systems, supply-chain management systems, or any type of Enterprise Resource Planning (“ERP”) systems, such as those provided by SAP AG of Walldorf, Germany or Oracle Corporation of Redwood Shores, Calif. In general, enterprise software systems 462 handle logistics, distribution, inventory, shipping, invoicing, accounting or other business functions for an enterprise. An enterprise may be a division, subsidiary or other business unit associated with one or more organizations.

As described in further detail below, integration module 460 merges product tracking data supplied by the enterprise software systems 462 into lot tracking system 10. Specifically, integration module 460 provides lot tracking system 10 with data integration and capture features for interfacing with enterprise software systems 462. Integration module 460 allows lot tracking system 10 to seamlessly integrate with one or more enterprise software systems 462 be capturing tracking data from enterprise software systems 462, processing the tracking data to ensure data integrity and completeness, and updating lot tracking system 10 to record the tracking data.

For example, during the general course of business, employees of the various enterprises (e.g., subsidiaries) enter data into enterprise software systems 462 in association with business activities. As a few examples, employees may interact with enterprise software systems 462 to record the purchasing of new assets (e.g., trucks or bins) or to record receipt or shipment of product in order to manage inventory levels. The employee typically enters the data through particular user interfaces presented by enterprise software systems 462. Some of the data provided may be relevant to product identity preservation. Further, in many cases, enterprise software systems 462 may not initially capture all of the data needed by lot tracking system 10 for identify preservation and tracking purposes.

To address these issues, integration module provides a user interface 470 by which an administrator specifies business activity definitions 466. As further illustrated below, each of business activity definitions 466 relates to one or more activities for the remote enterprises (e.g., lot shipment or asset purchases) and defines all of the data required by integration module 460 for recording the activity with lot tracking system 10. In other words, business activity definitions 466 specifies the particular data fields necessary for recording data with lot tracking system 10 for purposes of tracing and identify preservation. In many cases, business activity definitions 466 may specify data not presently captured by enterprise software systems 462. Integration module 460 utilizes business activity definitions 466 to verify the completeness of data received from enterprise software systems 462. Further, enterprise software systems 462 utilize business activity definitions 466 to ensure that the data collected from the users complies with the requirements of integration module 460 and lot tracking system 10.

For example, enterprise software systems 462 may be updated or configured to collect data matching the requirements specified by business activity definitions 466. For instance, suppose that prior to the update, enterprise software system 462A was used to record a business activity associated with a movement of bagged animal feed. Specifically, assume that enterprise software system 462A provided a user interface associated with this business activity that requested a product identifier, a quantity, a source, and a destination. Lot tracking system 10 may require all of this data, but may further require a lot number ID associated with the moved feed. In this circumstance, administrator 464 creates a business activity definition 466 associated with this particular business activity, and specifies the requirement of a lot number ID as well as the other data fields. Further, one or more of enterprise software systems 462 produce an updated user interface that requires the lot number ID whenever an employee enters data associated with the movement of bagged animal feed.

Export routines 463 export business activity data from enterprise software systems 462 to integration module 460. In particular, export routines 463 process newly entered data received by enterprise software systems 462 and extract all data relevant to lot tracking system 10 based upon the associated business activities being recorded. Export routines 463 then package the relevant data in the formats specified by business activity definitions 466. That is, export routines 463 executing on enterprise software systems 462 package relevant data for a given business activity in a consistent way that complies with the requirements set forth in business activity definitions 466. After extracting and packaging relevant product tracking data from all submitted business activities, export routines 463 send the relevant product tracking data to integration module 460 for processing and recording with lot tracking system 10. Export routines 463 may periodically (e.g., hourly, daily or monthly) send the packaged data in a large data set (e.g., file) referred to herein as a “batch.” Alternatively, export routines 463 may send the data in pseudo real-time, i.e., as the data is collected by enterprise software systems 462.

Integration module 460 receives the product tracking data relevant to lot tracking system 10 and records the product tracking data into lot tracking system 10. Specifically, integration module 460 receives product tracking data sent by export routines 463 executing on enterprise software systems 462. Integration module 460 processes the received product tracking data by business activity in view of business activity definitions 466 to verify that the received product tracking data contains all of the product tracking data required by lot tracking system 10. For example, assume the received product tracking data relates to a movement of bagged animal feed. For movements of bagged animal feed, lot tracking system 10 may require a product identifier, a quantity, a source, a destination, and a product lot ID. By application of a corresponding one of business activity definitions 466, integration module 460 verifies that the received product tracking data contains these data fields. As further illustrated below, business activity definitions 466 may specify data types associated with each of the data fields, and whether the data fields are optional or required.

If the received product tracking data for a business activity fulfills the requirements set by the associated business activity definition 466, integration module 460 submits the data for the business activity to lot tracking system 10. On the other hand, if the received product tracking data for a business activity does not fulfill the requirements, integration module 460 marks the data as non-compliant. For example, integration module 460 may stage the data in an a holding state, and send an electronic message to an individual associated with the submitting enterprise software system requesting correction to the submitted data.

During this process, integration module 460 maintains log 468 to record all batches received by integrator 460 from export routines 463. For each batch, log 468 may record a batch ID, a batch status, a time received, a time processed, a data source, an error count, a transferred time, and an accepted status for each string representation. Administrator 464 may access log 468 through interface 470 to review activity performed by integration module 460.

Integration module 460 may execute within the same operating environment as software platform 24. In other words, integration module 24 may execute on one or more computers (e.g., web servers or application servers) having access to database 26. Alternatively, integration module may execute independently from software platform 24, i.e., on separate computers. In either case, integration module 460 provides lot tracking system 10 with data integration and capture features, allowing seamless integration with one or more enterprise software systems 462.

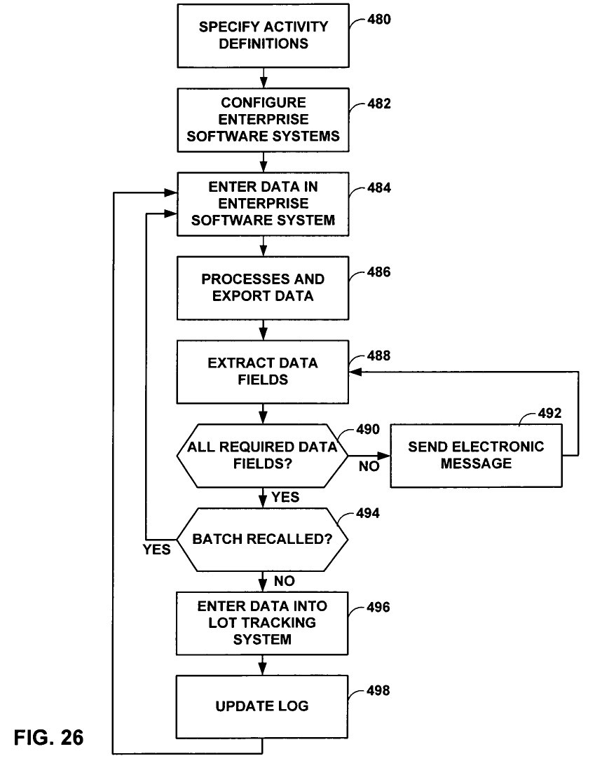

FIG. 26 is a flowchart illustrating an exemplary mode of operation for an embodiment of a tracking system that integrates data from a variety of enterprise software systems 462. Initially, administrator 464 interacts with user interface 470 to specify business activity definitions 466 (480). As discussed above, business activity definition 466 specifies a list of required product tracking data for a business activity recorded by one or more of enterprise software systems 462. Next, a user, e.g, administrator 464, configures enterprise software systems 462 to collect data that satisfies the requirements specified with business activity definitions 466 (482). For example, administrator 464 or another user may reconfigure one or more of enterprise software systems 462 to provide a new or modified user interface that collects all of the required data. Alternatively, enterprise software systems 462 may automatically create a new or modified user interface based the specified requirements. In addition, administrator 464 or other users deploy export routines 463 to enterprise software systems 462 to export the collected data to integration module 460.

After configuration, whenever a business activity occurs, an employee enters data with respect to that business activity into enterprise software system 462A (484). For example, an employee may interact with one of enterprise software systems 462 to record the purchase of new assets (e.g., trucks or bins) or to record receipt or shipment of product. At this point, enterprise software systems 462 collect all of the business activity data, including and data needed by lot tracking system 10 for purposes of tracking and tracing. At the close of a business day, for example, one of export routines 463 (e.g., export routine 463A on enterprise software system 462A) packages the newly entered data for exportation to integration module 460 (486). For example, export routine 462A may generate a string-based file containing all or portions of the business activity data submitted by the employee and send the file to integration module 460, e.g., via FTP or other communication means.

Upon receipt, integration module 460 extracts data fields from the product tracking data received from export routine 463A (488). In one embodiment, business activity definitions 463 installed on integration module 460 provides data definitions as to the format of the exported data, and integration module 460 extract the exported data in accordance with the format. For example, business activity definitions 466 may specify starting and ending offsets and data types for each data field, thereby providing a data map for use when extracting and processing the communicated data.

After integration module 460 extracts the product tracking data, integration module 460 further uses the business activity definition to verify that all required product tracking data are present (490). If any portion of the required product tracking data is not present within the exportation, integration module 460 marks the data as non-compliant and sends an electronic message requesting correction (492). In response, a user, possibly even the original employee that entered the data, provides the missing product tracking data or otherwise corrects the identified error. Integration module 460 again processes that the product tracking data and verifies that all necessary product tracking data are present.

Once all required data fields are present, integration module 460 checks whether the batch has been recalled (494). For example, the submitting enterprise software system 462 may issue an instruction to recall all or a portion of the exported data. For example, by recalling the data of a business activity, an employee can prevent incorrect data from entering lot tracking system 10. If the batch has not been recalled, integration module 460 enters the data into lot tracking system 10 (496). Integration module 460 then creates a record in log 468 (498).

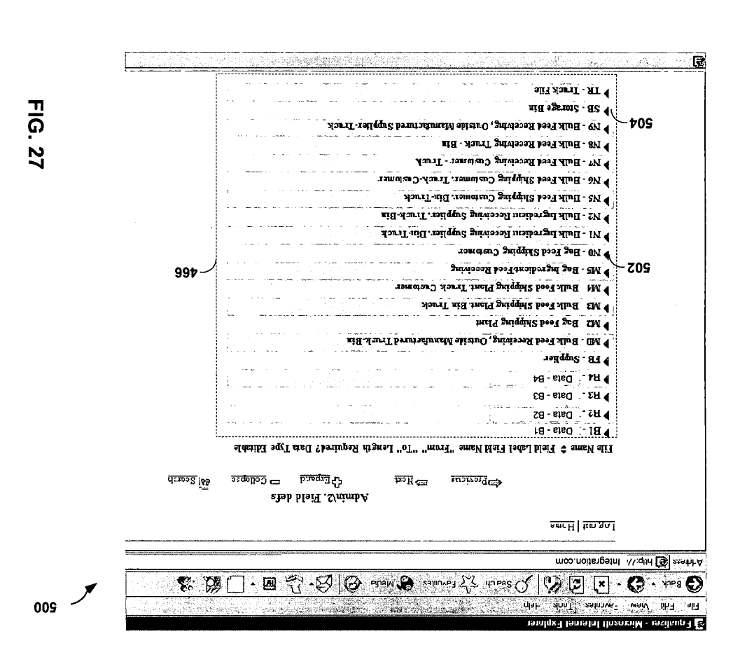

FIG. 27 is a screen illustration showing an exemplary user interface 500 provided by integration module 460 by which administrator 464 may review business activity definitions 466. In order to review the status of integration module 460, administrator 464 accesses interface 470. In the example of FIG. 27, interface 500 is presented through a web browser. In particular, user interface 500 displays a list of business activity definitions 466 installed within integration module 460. By selecting one of the business activity definitions 466 displayed in interface 500, administrator 464 can access the detailed data definitions for each of business activity definitions 466.

In this manner, user interface 500 displays the diversity of business activities that can be used with integration module 460. As one example, activity 502 relates to a “bag feed shipping customer” activity. Activity 504, on the other hand relates to a “storage bin” activity. Preceding each business activity definitions 466 is a two character identification code, such as B1-B4, FB, M0, M2-M5, N0-N9, SB and TR, referred to as a “record type.”

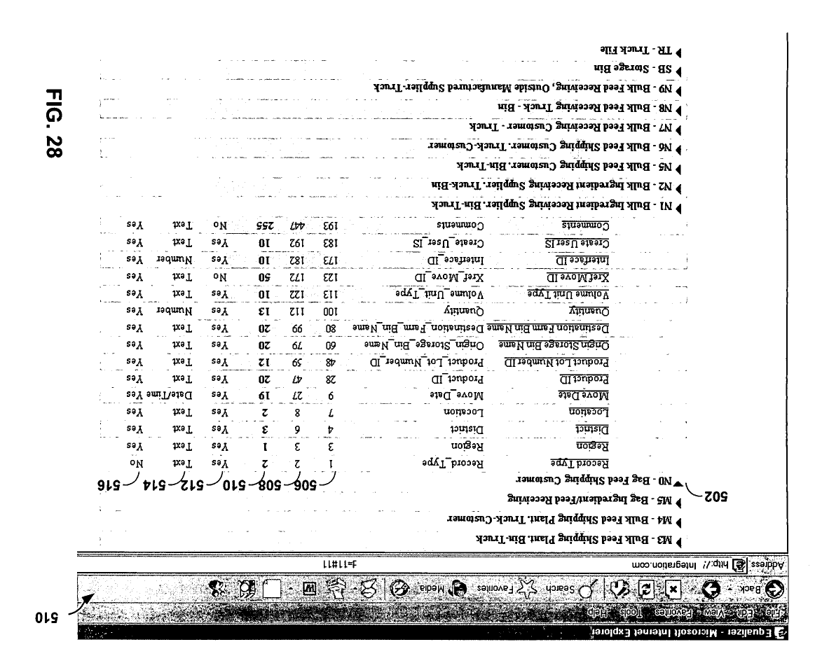

FIG. 28 is a screen illustration showing an exemplary user interface 510 presented by integration module 460 when administrator 464 elects to review the specific data fields for one of business activity definitions 466. As shown in interface 510, administrator 464 has selected the “Bag Feed Shipping Customer” business activity definition 502. In this example, business activity definition 502 has fifteen data fields, and the format of each data field is specified using columns 506 through 516. For example, column 502 lists a position of a starting character within a string representation of the data set, column 504 lists a position of an ending character, and column 506 lists a length of the data field in the string representation. For instance, the “district” data field begins at character 4, ends at character 6, and is 3 characters long.

Column 512 specifies whether a particular data field is required or optional. The “comment” data field, for example, is not required. Column 514 specifies the data type of each data field. In interface 510, data fields can either be “text,” “Number,” or “Date/Time.” Column 516 specifies whether or not a user can edit the data field to, for example, address any errors identified while processing the exported data. For instance, a user cannot edit the “record type” data field.

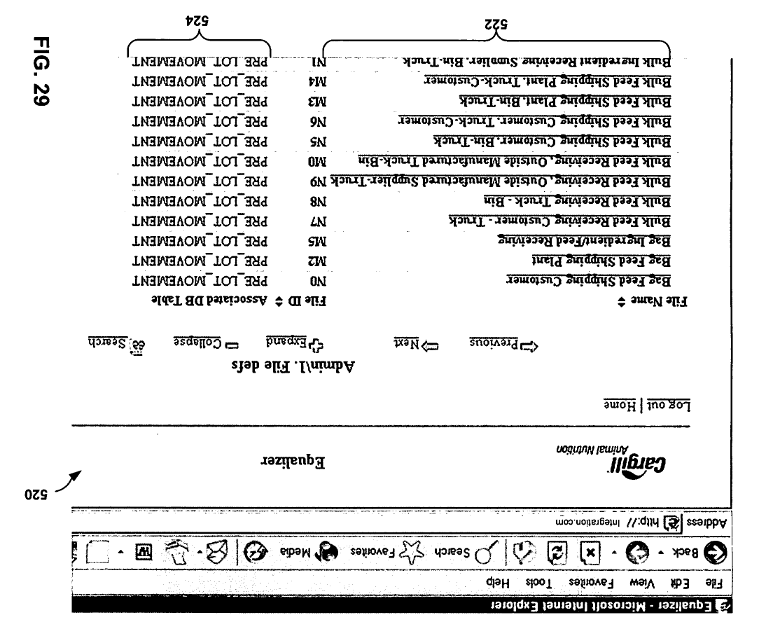

FIG. 29 is a screen illustration showing an exemplary user interface 520 for reviewing relationships between business activity definitions 466 and database tables 524 maintained within database 26. After integration module 460 has verified that a processed transaction includes all required data fields, integration module 460 inserts the data into lot tracking system 10 based on the tables specified by user interface 520. For example, database 26 of lot tracking system 10 may be a relational database composed of one or more related tables. Integration module 460 determines in which tables to record the processed data in accordance with the specified tables. In this manner, integration module 460 may be easily configured to properly record the exported data. In the example of FIG. 29, all of the business activities definitions 466 are associated with the “PRE_LOT_MOVEMENT” table in a relational database.

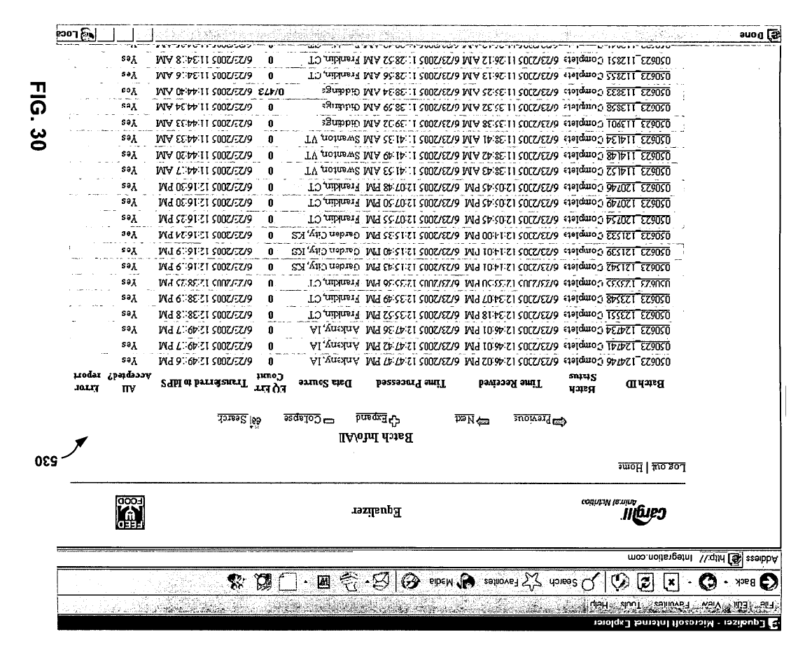

FIG. 30 is a screen illustration showing an exemplary user interface 530 for reviewing log 468. In this example, interface 530 displays a list of batches. Each time integration module 460 transfers a new batch to lot tracking system 10, integration module 460 creates a new entry in the list of batches. As one example, each entry in the list of batches contains data in twelve columns: a “Batch ID” that provides a unique batch identifier, a “Batch Status” that lists a status for the batch (e.g., completed or error), a “Time Received” indicating when the batch was received, a “Time Processed” indicating when the batch was processed, a “Data Source” indicating a data source from which the batch was received, a “EQ Err Count” proving a count of any identified errors, a “Transferred to IdPS” indicating a date and time the data was transferred to lot tracking system 10, an “All Accepted?” status indicating whether all of the data was accepted, and an “Error Report” indicating whether any error report was produced.

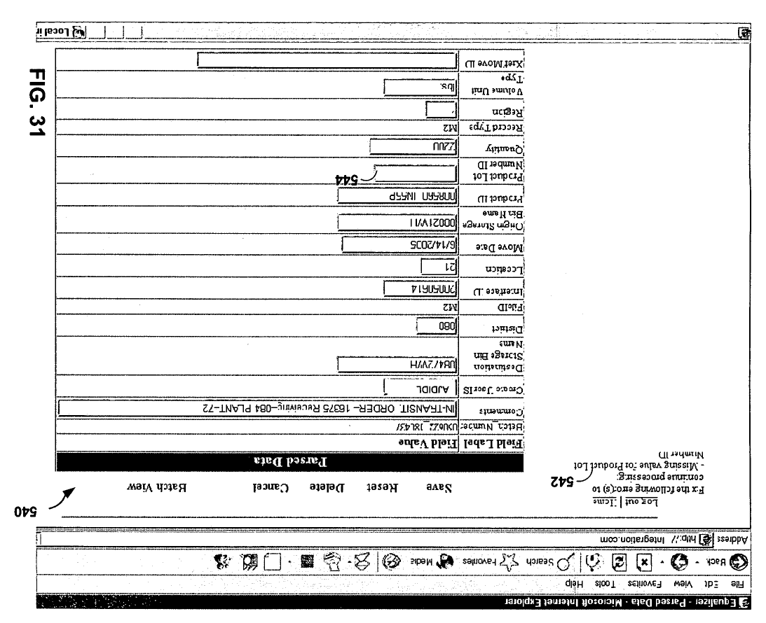

FIG. 31 is a screen illustration showing an exemplary user interface 540 for entering missing data or otherwise correcting any errors associated with a particular data set. As described above, in the event integration module 460 detects one or more errors, integration module 460 may send an electronic message to an employee responsible for correcting the errors. When the employee receives the message, the employee may select a universal resource locator (URL) within the message, causing integration module 460 to direct the employee to user interface 540.

In the example of FIG. 31, user interface 540 displays a message 542 indicating that the “product lot number ID” is missing for this exemplary set of exported data. To correct this, an employee enters the product lot number ID in a text box 544. After entering the missing data, the employee can resubmit the data for entry into lot tracking system 10.

A number of embodiments of the present invention have been described. Nevertheless, it will be understood that various modifications may be made without departing from the spirit and scope of the invention. Accordingly, other embodiments are within the scope of the following claims.

1. A method comprising:
receiving, with an integration module, data from one or more enterprise software systems;
applying a data definition to the data with the integration module to verify that the data complies with requirements of an identity preservation system; and
recording the data to the identity preservation system upon verification of the data.

2. The method of claim 1, further comprising formatting the data at the enterprise software systems in a common format based on the data definition.

3. The method of claim 1, wherein applying a data definition to verify the data comprises:
processing the data to identify a business activity code;
selecting the data definition from a set of business activity definitions installed on the integration module, wherein the data definition specifies a set of data fields required by the identify preservation system; and
determining whether the data from the enterprise software system contains all of the data fields required by the selected data definition.

4. The method of claim 3, further comprising verifying that data fields present in the data conform to data types specified by the selected data definition.

5. The method of claim 3, further comprising verifying the extracted data comprises verifying that each data field present in the data has a length equal to a length specified by the business activity definition for the data field.

6. The method of claim 1, wherein receiving the data comprises receiving a string representation of a business activity from the enterprise software systems.

7. The method of claim 6, wherein applying a data definition to verify the data comprises comparing the string representation against a format specified by a business activity definition installed on integration module.

8. The method of claim 6, wherein verifying the package comprises verifying that data fields begin and end at locations within the string representation specified by a business activity definition.

9. The method of claim 1, wherein the enterprise software systems are Enterprise Resource Planning (“ERP”) systems.

10. The method of claim 1, further comprising configuring at least one of the enterprise software systems to collect data in accordance with the data definition of the identify preservation system.

11. The method of claim 10, wherein configuring the enterprise software systems comprises modifying a user interface of at least one of the enterprise software systems to collect additional data not previously collected by the enterprise software system that relates to product tracking.

12. The method of claim 1, further comprising exporting routines on the enterprise software systems to export the data to interrogator module.

13. The method of claim 12, wherein the export routines are executed periodically or in real-time.

14. The method of claim 1, wherein the business activity relates to one of:
a movement of a product;
a production site,
transportation mechanism, or a
storage facility.

15. The method of claim 1, further comprising presenting a user interface to allow a user to view a list of installed data definitions.

16. The method of claim 15, further comprising presenting a user interface to allow a user to select one of the data definitions and edit a list of data fields associated with the selected data definition.

17. The method of claim 1, further comprising presenting a user interface to allow a user to view a list of relationships between each of the data definitions and one or more tables in a database of the identity preservation system.

18. The method of claim 1, further comprising sending an electronic message to a user when the data fails to comply with the requirements of the identity preservation system.

19. The method of claim 18, further comprising providing an interface through which the user may amend the product tracking data to correct the non-compliance of the data.

20. The method of claim 1, further comprising maintaining a log of data received from the enterprise software systems.

21. The method of claim 1, wherein recording the data comprises:
inserting the data including a source location, a destination location and a transportation device into a database as product tracking data; and
generating a report indicating commingled products based on the product tracking data.

22. The method of claim 21, wherein generating a report comprises determining a plurality of lots based on the product tracking data.

23. The method of claim 22, wherein determining a plurality of lots comprises assigning a new lot identifier when the products are commingled at a location.

24. The method of claim 21, wherein the product tracking data includes a designation of a farm, a field and time harvested.

25. The method of claim 1,
wherein recording the data comprises storing the data as product tracking data associated with receiving of a lot,
wherein the product tracking data includes an indication of a time in, a time out, a location identification, and an indication of whether the location was clean and empty when receiving the lot.

26. The method of claim 25, wherein the location information indicates a transportation device used to transport the lot.

27. The method of claim 25, further comprising tracing the movement of the lot to determine each location that the lot has been in and to determine every product that has been commingled with the lot.

28. A system comprising:
a plurality of enterprise software systems, each of which collects business activity data and produces product tracking data from at least a portion of the collected business activity data; and
a product identity preservation system having an integration module, wherein the integration module receives the product tracking data from the enterprise software systems and stores the product tracking data into the product identity preservation system.

29. The system of claim 28, further comprising a set of data definitions,
wherein each of the data definitions corresponds to a different business activity associated with the business activity data stored by the enterprise software systems, and
wherein each of the data definitions specifies a set of data fields required by the product identify preservation system for each of the business activities.

30. The system of claim 29, wherein the enterprise software systems produce the product tracking data in common formats based on the data definitions

31. The system of claim 29, wherein integration module processing the product tracking data from to identify a business activity code, and applies one of the data definitions based on the business activity code to determine whether the product tracking data from the enterprise software system contains all of the data fields required by the product identify preservation system.

32. The system of claim 29, wherein the interrogator module provides a user interface through which a user can edit the data definitions.

33. The system of claim 29, further comprising a user interface through which a user can edit relationships between the data definitions and tables within a database of the product identity preservation system.

34. The system of claim 29, wherein the integration module sends an electronic message if the product tracking data does not conform to the requirements of the product identify preservation system.

35. The system of claim 28, wherein at least one of the enterprise software systems is an Enterprise Resource and Planning Systems.

36. The system of claim 28, wherein each of the enterprise software systems comprise:
an interface through which the business activity data is submitted; and
an export routine to extract the product tracking data from the submitted business activity data and package the product tracking data for communication to the product identify preservation system.

37. The system of claim 36, wherein at least one of the interfaces of the enterprise software system is modified to collect additional data that relates to product tracking not previously collected by the enterprise software system.

38. The system of claim 28, wherein a business activity data relates to an action performed on a production location, storage unit or a transport unit.

39. The system of claim 28, wherein a business activity data relates to a movement of a product.

40. The system of claim 28, wherein the product identity preservation system stores the product tracking data as lot tracking information.

41. The system of claim 28, wherein the product identity preservation system comprises:
a database to store the produce tracking data as movement tracking information relating to a unique identification of a lot, a location of the lot, and timing information; and
a server to generate a tracking screen for tracing the movement and storage of the lot based on the database and to identify any commingled products.

42. The system of claim 41, wherein the server further comprises a program configuration module configured to allow a customer to define a program for tracking the lot.

43. The system of claim 42, wherein the program provides a checklist for handling the lot.

44. The system of claim 43, further comprising a contract module that allows the customer to generate a contract with a producer for a quantity of a product defining the lot.

45. The system of claim 42, wherein the program configuration module allows the customer to define certification requirements for handling the lot.

46. The system of claim 41, further comprising an audit, certification and testing module configured to allow transporters of the lot to identify a specific transportation device, a time the lot enters the transportation device, a time the lot leaves the transportation device, and a clean and empty status of the transportation device.

47. The system of claim 41, wherein the system is in communication with a business entity and receives movement tracking information from the business entity.

48. The system of claim 41, further comprising a contract module for facilitating and monitoring contracts wherein the contract module prevents the generation of a contract in excess of a predetermined order maximum.

49. The system of claim 41, further comprising an audit, certification and testing module configured to allow storage facilities that store the lot to identify a specific storage location, a time the lot enters the storage location, a time the lot leaves the storage location, and a clean and empty status of the storage location.

50. A computer-readable medium comprising instructions, wherein the instructions cause a programmable processor to:
receive with an integration module data from one or more enterprise software systems;
apply a data definition to the data with the integration module to verify that the data complies with requirements of an identity preservation system; and
record the data to the identity preservation system upon verification of the data.
